(19) United States
(12) Patent Application Publication
(10) Pub. No.: US 2025/0363387 A1
(43) Pub. Date: Nov. 27, 2025

(54) FEATURE COMMUNICATION FOR NETWORK PERFORMANCE IMPROVEMENT IN FEDERATED MODELS

(71) Applicant: U.S. Bancorp, National Association, Minneapolis, MN (US)

(72) Inventors: Rahul Sharma, Fremont, CA (US); Narasimha 'Murthy' M Kunchakarra, Fremont, CA (US)

(73) Assignee: U.S. Bancorp, National Association, Minneapolis, MN (US)

(21) Appl. No.: 18/933,802

(22) Filed: Oct. 31, 2024

Related U.S. Application Data
(63) Continuation-in-part of application No. 18/670,710, filed on May 21, 2024.

(51) Int. Cl. G06N 3/098

(52) U.S. Cl. CPC G06N 3/098

(57) ABSTRACT

A method and related system may send a model to first client devices and second client devices, where the model uses an initial set of features, and where the first client devices generates a first latent feature type based on first initial feature of the first client devices, and where the second client devices generates a second latent feature type based on second initial feature of the second client devices. The method may include obtaining first latent feature for the first latent feature type from the first client devices and second latent feature for the second latent feature type from the second client devices. The method may include generating a refined model based on the model, wherein the refined model uses, as inputs, features of the first latent feature type and the second latent feature type based on the first latent feature and the second latent feature values.

### CROSS-REFERENCE TO RELATED APPLICATIONS

This application claims the benefit of priority as a continuation-in-part to U.S. patent application Ser. No. 18/670,710, filed May 21, 2024, the entirety of which is incorporated by reference herein.

### BACKGROUND

Within the realm of digital actions abundant with data, the significance of smart predictive models cannot be overstated, as they play a crucial role in enhancing efficiency and fostering value. These models form elements of recommendation systems, which can be customized to propose or identify potential recommendations by analyzing a user's past actions and anticipated future trends. However, employing conventional training techniques and approaches may constrain the precision, resilience, or adaptability of these recommendations, owing to limitations inherent in a model's configuration or parameters.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates an example system for collaborative machine learning model generation, in accordance with an implementation;

FIG. 2 illustrates an example system for collaborative machine learning model generation, in accordance with an implementation;

FIG. 3 illustrates an example sequence for collaborative machine learning model generation, in accordance with an implementation;

FIG. 4 illustrates an example sequence for collaborative machine learning model generation, in accordance with an implementation;

FIG. 5 illustrates an example sequence for collaborative machine learning model generation, in accordance with an implementation;

FIG. 6 illustrates an example method for collaborative machine learning model generation, in accordance with an implementation;

FIG. 7 illustrates an example system for refining a machine learning model with different sets of latent features, in accordance with an implementation;

FIG. 8 illustrates an example sequence for refining a machine learning model with different sets of latent features, in accordance with an implementation;

FIG. 9 illustrates an example method for using latent features to perform collaborative machine learning model generation, in accordance with an implementation;

FIG. 10 illustrates a first example system that provides initial feature values usable for training cross-pollinated machine learning models;

FIG. 11 illustrates a second example system that provides latent feature values usable for training cross-pollinated machine learning models;

FIG. 12 illustrates a first example system that uses latent feature values to train machine learning models;

FIG. 13 illustrates a second example system that uses latent feature values to train machine learning models;

FIG. 14 illustrates a third example system that uses latent feature values to train machine learning models;

FIG. 15 discloses a computing environment in which aspects of the present disclosure may be implemented, in accordance with an implementation; and

FIG. 16 illustrates an example machine learning framework that techniques described herein may benefit from.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As mentioned above, in the data-rich ecosystem of digital actions, the importance of intelligent predictive models that can accurately facilitate efficiency is paramount. These models are integral components of recommendation and other systems, which may be configured to suggest potential actions to users based on their historical behavior and predicted future behavior. Traditionally, these recommendation systems rely on single predictive models. However, this approach can limit the accuracy, robustness, and/or context-sensitivity of the suggestions due to the inherent constraints of relying on a single model's structure or parameters.

A computer implementing the systems and methods described herein can address the aforementioned technical deficiencies and provide machine learning models with improved accuracy and enhanced capabilities to handle complex relationships between features. The computer can do so using multiple machine learning models that are separately trained on different computing devices accessed by unique users to generate personalized recommendations for potential actions for the respective users. The computer can use one of the machine learning models as a ground truth to train another machine learning model for potential action recommendation generation, thus causing the further trained machine learning model to function as a predictive model for a blend of the two users that originally trained the two machine learning models. The trained machine learning model may later be used to generate potential action recommendations for a third user accessing the computer. The computer can train the machine learning model based on recommendations and selections by the third user. By using selections of three different users to train the machine learning model, the computer can improve the machine learning model's accuracy, reduce overfitting, facilitate better capture of complex relationships between input features, and improve noise filtering of input features, among other technical benefits.

In one example, the aforementioned multi-model system is relevant to providing a concrete solution to the limitations of single-model systems because it takes advantage of the strengths and mitigates the weaknesses of separately trained models. In addition, the system can personalize the recommendations to individual user accounts, maximizing the system's efficacy in a real-world environment where different users can have different preferences.

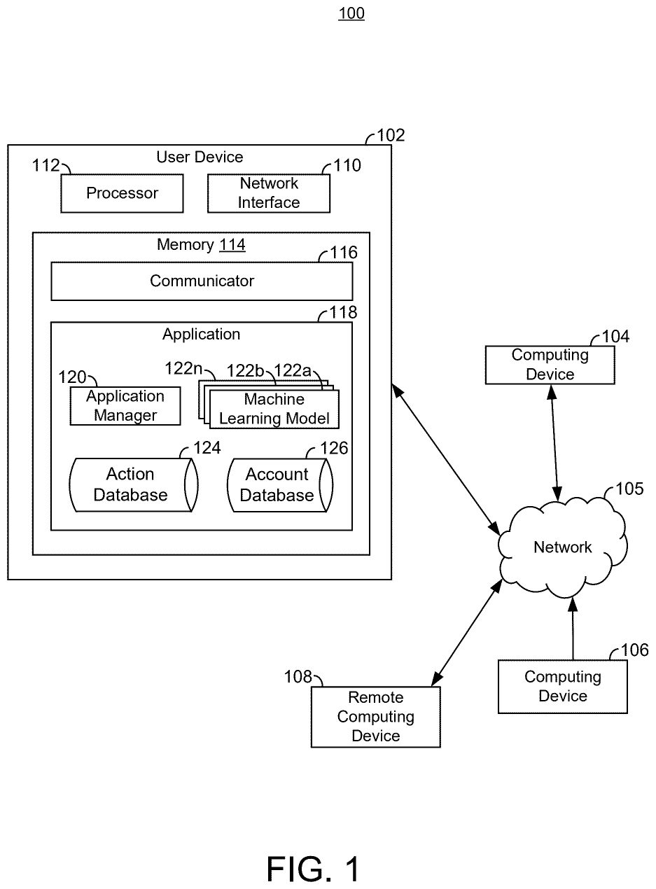

### FIG. 1

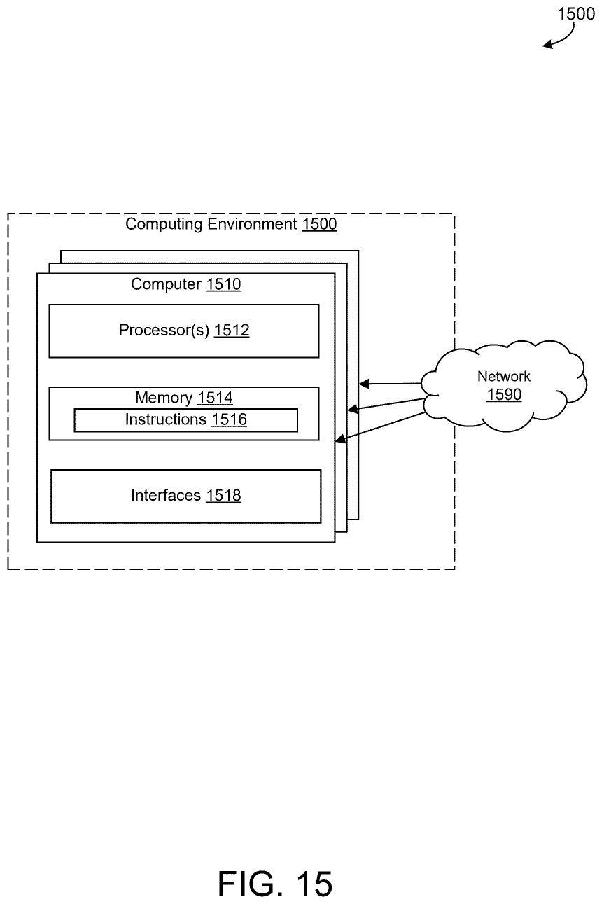

For example, FIG. 1 illustrates an example system 100 for collaborative machine learning model generation, in accordance with an implementation. In brief overview, the system 100 can include a user device 102, a computing device 104, a computing device 106, and/or a remote computing device 108. The user device 102, the computing device 104, the computing device 106, and/or the remote computing device 108 can each include one or more aspects or features described elsewhere herein, such as in reference to the computing environment 1500 of FIG. 15. The user device 102 can be configured to execute an application stored locally on the user device 102 to consolidate the learning of machine learning models trained to generate recommendations for potential actions on or at different computing devices (e.g., the computing devices 104 and 106) into a single machine learning model. The user device 102 can then continue to train the consolidated machine learning model based on predictions and selections made locally on or at the user device 102. Using the shared learning of training performed at different computing devices, the user device 102 can improve the accuracy of the machine learning model in generating recommendations for potential actions for a user. In doing so, the user device 102 can configure the machine learning model to handle complex relationships between features when generating recommendations for potential actions. The system 100 may include more, fewer, or different components than shown in FIG. 1.

The user device 102, the computing device 104, the computing device 106, and/or the remote computing device 108 can include or execute on one or more processors or computing devices and/or communicate via a network 105. The network 105 can include computer networks such as the Internet, local, wide, metro, or other area networks, intranets, satellite networks, and other communication networks, such as voice or data mobile telephone networks. The network 105 can be used to access information resources such as web pages, websites, domain names, or uniform resource locators that can be presented, output, rendered, or displayed on at least one computing device (e.g., the user device 102, the computing device 104, the computing device 106, and/or the remote computing device 108), such as a laptop, desktop, tablet, personal digital assistant, smartphone, portable computer, or speaker.

The user device 102, the computing device 104, the computing device 106, and/or the remote computing device 108 can include (e.g., each include) or utilize at least one processing unit or other logic devices such as a programmable logic array engine or a module configured to communicate with one another or other resources or databases. As described herein, computers can be described as computers, computing devices, user devices, or client devices. The user device 102, the computing device 104, the computing device 106, and/or the remote computing device 108 may each contain a processor and a memory. The components of the user device 102, the computing device 104, the computing device 106, and/or the remote computing device 108 can be separate components or a single component. The system 100 and its components can include hardware elements, such as one or more processors, logic devices, or circuits.

The user device 102, the computing device 104, and/or the computing device 106 can each be an electronic computing device (e.g., a cellular phone, a laptop, a tablet, or any other type of computing device). The user device 102, the computing device 104, and/or the computing device 106 can each include a display with a microphone, a speaker, a keyboard, a touchscreen, or any other type of input/output device.

Users can access a platform provided by the remote computing device 108 through the user device 102, the computing device 104, and/or the computing device 106 to view potential actions (e.g., an action associated with software running or a service provided by the user device 102, the remote computing device 108, or another, or entities associated therewith) requested by the users and/or otherwise manage an account the user has with an institution (e.g., a social media institution, a retail institution, a financial institution, another institution, or combinations thereof) that manages an application stored locally on each of the user device 102, the computing device 104, and/or the computing device 106. In one example, a user of the computing device 104 can provide an input into the computing device 106 requesting one or more potential actions of a particular type. The computing device 106 can execute an application to retrieve multiple potential actions of the requested type from the remote computing device 108. The remote computing device 108 can transmit potential actions of the requested type to the computing device 104. The computing device 104 can execute a machine learning model to select one or more potential actions from the received potential actions and present the selected one or more potential actions to the user. The user can select one of the presented potential actions. In response to the user's selection, the computing device 104 can transmit the selected potential action to the remote computing device 108 to complete through the user's account with the platform provided by the remote computing device 108.

The computing devices 104 and 106 can each train a machine learning model (e.g., a neural network, a support vector machine, a random forest, etc.) to generate recommendations for potential actions. For example, the computing device 104 can store and execute an application that is configured to communicate with the remote computing device 108. The application can be configured to access the platform hosted by the remote computing device 108 that is configured to manage an account with an associated entity. Through the application, the computing device 104 can execute the machine learning model using an account identifier of an account and/or historical actions performed through the account to generate individual recommendations (e.g., records or lists) identifying sets of potential actions (e.g., sets of potential actions selected from a plurality of actions the computing device 104 receives or retrieves from the remote computing device 108) and present the sets of potential actions to a user of the computing device 104. A set of potential actions can be or include one or more potential actions of a specific type (e.g., a specific action type), such as a specific type of action, an action with specific attributes or values, etc., which may be input by a user into the computing device 104 to initiate the process of generating a recommendation for the set of potential actions. The user can input a selection of one or more potential actions from each of the sets of potential actions or select an option or element indicating not to select any of the potential actions. The computing device 104 can receive the selections and train the machine learning model based on the selections, such as by using back-propagation techniques using the selections as labels or the ground truth and based on one or more differences between the output sets of potential actions and the selections of potential actions and/or selections indicating not to select any potential action by the user. The computing device 104 can adjust the weights and/or parameters of the machine learning model based on the user's selections over time to train the machine learning model. Thus, the user device 102 can generate individualized recommendations for sets of potential actions for the user. The computing device 106 can train a different machine learning model in the same or a similar manner using an application stored locally on the computing device 106, such as by using an account identifier for a different account and user and/or historical actions performed through the account and user.

The computing devices 104 and 106 can transmit the machine learning models trained locally at the respective computing devices 104 and 106 to the user device 102. For example, subsequent to training the respective machine learning models based on selections (or non-selections) of potential actions made by users of the computing devices 104 and 106, the computing devices 104 and 106 can transmit the machine learning models to the user device 102. The computing devices 104 and 106 can transmit the machine learning models to the user device 102 responsive to determining the machine learning models are accurate to at least an accuracy threshold (which may be determined based on a number, portion, or percentage of recommendations generated by the machine learning models from which a user selected a potential action, in some cases compared with the number of recommendations for which the user did not select a potential action) and/or responsive to a request from the user device 102. In some embodiments, the computing devices 104 and 106 can transmit the respective machine learning models to the user device 102 responsive to a user input at the respective computing devices 104 and 106. The computing devices 104 and 106 can transmit the machine learning models to the user device 102 directly through the network 105 and/or through the remote computing device 108. The user device 102 can receive the machine learning models and store the machine learning models in memory.

The user device 102 may comprise one or more processors that are configured to receive and train machine learning models to generate recommendations for potential actions to a user accessing the user device 102. The user device 102 may comprise a network interface 110, a processor 112, and/or memory 114. The user device 102 may communicate with the computing device 106 and/or the computing device 106 via the network interface 110, which may be or include one or more antennas or other network device that enables communication across a network and/or with other devices. The processor 112 may be or include an ASIC, one or more FPGAs, a DSP, circuits containing one or more processing components, circuitry for supporting a microprocessor, a group of processing components, or other suitable electronic processing components. In some embodiments, the processor 112 may execute computer code or modules (e.g., executable code, object code, source code, script code, machine code, etc.) stored in memory 114 to facilitate the activities described herein. The memory 114 may be any volatile or non-volatile computer-readable storage medium capable of storing data or computer code.

The memory 114 may include a communicator 116 and an application 118. The application 118 can include an application manager 120, machine learning models 122a-n (individually machine learning model 122, and, in groups, machine learning models 122), an action database 124, and/or an account database 126. In brief overview, the components 116-124 may receive a first machine learning model (e.g., the machine learning model 122a) from the computing device 104 and a second machine learning model (e.g., the machine learning model 122b) from the computing device 106. The components 116-122 can execute the first machine learning model and the second machine learning model to generate recommendations for potential actions. The components 116-122 can train the second machine learning model using the recommendations generated by the first machine learning model as a ground truth. The components 116-122 can use the second machine learning model to generate recommendations for potential actions for a user accessing the user device 102. In this way, the components 116-122 can integrate multiple machine learning models trained with different training data or different users to generate a new machine learning model that is configured to generate more accurate recommendations for potential actions and/or take into account more complex relationships between features of an input.

The action database 124 can be or include a relational database or a graphical database. The action database 124 can include action data for actions performed by different accounts (e.g., actions performed by entities associated with the accounts). The accounts can be accounts associated with or managed by the institution that owns or manages the remote computing device 108, for example. The accounts can correspond with actions or store data of or for individual users. The action data can include, for individual actions performed through the accounts, an action amount (e.g., values or parameters associated with the action), a timestamp indicating the time and/or date in which the action was performed or completed, identifications of the one or more accounts participating in the action (e.g., the action may involve an interaction with another account), the location of the action, a code for the action, and/or any other data regarding the actions. The action database 124 can store the action data in records and/or data structures (e.g., tables).

The user device 102 can store data for actions in the action database 124 over time. For example, the user device 102 can receive action data from the computers and/or servers that manage or otherwise facilitate the actions as the actions are processed and/or completed. Responsive to receiving the action data, the user device 102 can store the action data in the action database 124 in records for the individual actions. The user device 102 can store the records in the data structures within the action database 124 for the accounts participating in the actions. The user device 102 can generate and store such records for actions as the user device 102 receives action data for the actions over time. In some cases, the action database 124 may only include action data for actions performed through the application 118 and/or the account of the user accessing the application 118. In some cases, the action database 124 is stored at the remote computing device 108, and the user device 102 requests action data from the remote computing device to retrieve action data.

The account database 126 can be or include a relational or graphical database configured to store data (e.g., account data) for different accounts. The account database 126 can store records (e.g., tables or data structures) for each account that includes data for the account. The account data can include, for example, name, age, gender, time the account has been open, subscription information if the account is a subscription, etc. Each record can include one or more field-value pairs that each correspond to a different type of data.

The communicator 116 may comprise programmable instructions that, upon execution, cause the processor 112 to communicate with the computing device 106, the computing device 106, and/or any other computing device. The communicator 116 can be or include an application programming interface (API) that facilitates communication between the user device 102 (e.g., via the network interface 110 of the user device 102) and other computing devices. The communicator 116 may communicate with the computing device 104, the computing device 106, the remote computing device 108, and/or any other computing devices across a network (e.g., the network 105).

In one example, the communicator 116 can establish a connection with a computing device (e.g., the computing device 104 or the computing device 106). The communicator 116 can establish the connection with the computing device over the network 105. To do so, the communicator 116 can communicate with the computing device across the network 105. In one example, the communicator 116 can transmit a syn packet to the computing device 106 (or vice versa) and establish the connection using a TLS handshaking protocol. The communicator 116 can use any handshaking protocol to establish a connection with the computing device 106. The user device 102 can communicate with the computing device 106 over the established connection.

The application 118 may comprise programmable instructions that, upon execution, cause the processor 112 to facilitate communication with the remote computing device 108 to enable a user to access the platform provided by the remote computing device 108. In some embodiments, the application 118 can be an API and be a part of or include the communicator 116. The application 118 can generate user interfaces with data from the remote computing device 108 and present the user interfaces on a display of the user device 102. In some cases, the application 118 can use machine learning models or machine learning techniques to select a set of potential actions to include in a user interface and present the user interface on the display. A user can select a potential action from the set of potential actions, and the application 118 can transmit the selection (e.g., an identification of the selected potential action) to the remote computing device 108. The remote computing device 108 can receive the selection and facilitate or complete the action.

The application manager 120 of the application 118 can receive the machine learning models from the computing devices 104 and 106. The machine learning models received from the computing devices 104 and 106 can be the machine learning models 122a and 122b, respectively. The application manager 120 may comprise programmable instructions that, upon execution, cause the processor 112 to perform different operations using the application 118, such as training and/or executing the machine learning models 122 to generate sets of potential actions or facilitate a user experience of the user accessing the application 118 on the user device 102. The application manager 120 can communicate or interact with the remote computing device 108 to transmit and/or receive data for an account of a user accessing the user device 102.

The application manager 120 can manage the machine learning models 122. In doing so, the application manager 120 can facilitate reception and/or retrieval of the machine learning models 122 from other computing devices. For example, the application manager 120 can receive the machine learning models 122a and 122b from the computing devices 104 and/or 106 after the computing devices 104 and/or 106 transmit the respective machine learning models 122a and 122b. The application manager 120 can receive or retrieve the machine learning models 122a and 122b from the computing devices 104 and/or 106 responsive to an input request at the user device 102. For instance, the user accessing the user device 102 can input a request for a machine learning model that is configured to generate recommendations for sets of potential actions to provide to the user. Responsive to the input, the application manager 120 can transmit a message to the remote computing device 108 and/or the computing devices 104 and/or 106 for a machine learning model per the request. In cases in which the application manager 120 transmits the request to the remote computing device 108, the remote computing device 108 can receive the request and prompt (e.g., transmit a message to) the computing devices 104 and/or 106 for the requested machine learning model. The computing devices 104 and/or 106 can receive the request from the application manager 120 and/or the remote computing device 108 and automatically transmit the machine learning models 122a and 122b to the user device 102 and/or present a message (e.g., a push notification or mailbox message) at user interfaces displayed on the computing devices 106 and/or 108 indicating the request. In cases in which the computing devices 104 and/or 106 do not automatically transmit the machine learning models 122a and 122b to the user device 102, the computing devices 106 and/or 108 can transmit the machine learning models 122a and 122b to the user device 102 responsive to receiving an input from at the respective computing devices 104 and/or 106 indicating to share or transmit the machine learning models 122a and 122b to the user device 102. The computing devices 104 and/or 106 can transmit the machine learning models 122a and 122b to the user device 102 by transmitting copies of the machine learning models 122a and 122b such that the computing devices 104 and/or 106 can continue to use the machine learning models 122a and 122b to generate recommendations for sets of potential actions locally. The application manager 120 can also manage machine learning models local to the user device 102, such as by facilitating the creation, updating, use, and destruction of such models as relevant.

In some embodiments, the computing devices 104 and/or 106 can transmit the machine learning models 122 to the user device 102 without receiving a request or message that originated from the user device 102. For example, users accessing the computing devices 104 and/or 106 can select an option to share or transmit the machine learning models 122 to the user device 102. The users can do so, for example, by inputting an identifier (e.g., a numerical or alphanumerical identifier) of the account of the user accessing the user device 102 and/or an identifier (e.g., an Internet Protocol address, a MAC address, etc.) of the user device 102. The computing devices 104 and/or 106 can receive the input and transmit the machine learning models 122 to the user device 102 responsive to the input, such as based on the identifiers of the input.

In some embodiments, the user device 102 can request a machine learning model that is configured to generate recommendations of potential actions for a specific type of action. For example, the user accessing the user device 102 can receive an input indicating a type of action. Based on the input, the user device 102 can transmit a request for a machine learning model that is configured to generate recommendations of the potential actions for the specific type of action. In another example, users accessing the computing devices 104 and/or 106 can indicate a type of action in an input to the respective computing devices 104 and/or 106. The computing devices 104 and/or 106 can identify the type of action from the request or input and transmit a machine learning model configured to generate recommendations of potential actions for the input type of action to the user device 102.

The application manager 120 can receive the machine learning models 122 from the computing devices 104 and/or 106 and store the machine learning models 122 in memory 114. In some cases, the application manager 120 can store the machine learning models 122 in memory 114 with indications of the types of potential actions for which the machine learning models 122 are configured to generate recommendations. The application manager 120 can receive and/or retrieve any number of machine learning models from different computing devices. The retrieved machine learning models can be configured to generate recommendations for potential actions of any type.

The machine learning models 122 may each be or include a neural network, a support vector machine, a random forest, a large language model, or any other type of machine learning model. The machine learning models 122 may be or include machine learning models that have been received or retrieved from different computing devices, such as the computing devices 104 and/or 106. The machine learning models 122 may be or include models that are each configured to generate recommendations for specific types of actions and/or models that are agnostic to the types of the actions. The machine learning models 122 may have been trained at the other computing devices, such as by users accessing the computing devices, to make selections of potential actions prior to being transmitted to the user device 102. The application manager 120 may further train one or more of the machine learning models 122 locally after receiving the machine learning models 122.

The application manager 120 can integrate or combine the machine learning models 122 together. For example, the application manager 120 can use outputs from the machine learning model 122a received from the computing device 104 to train the machine learning model 122b received from the computing device 106. The application manager 120 may do so using the outputs of the machine learning model 122a as a ground truth for outputs from the machine learning model 122b that were both generated based on the same input. For instance, the user accessing the user device 102 may select an option at the user device 102 to indicate to use the machine learning models 122a as the ground truth to train the machine learning model 122b. The application manager 120 can identify the selection and retrieve the selected machine learning models 122a and 122b from memory 114. The application manager 120 may then use the machine learning model 122a to train or finetune the machine learning model 122b based on the outputs of both machine learning models 122a and 122b.

The application manager 120 may use a training data set of account identifiers and/or action data of historical actions performed by the accounts associated with the account identifiers to train the machine learning model 122b. For example, the application manager 120 may generate a training data set that includes multiple instances that each include an account identifier and/or historical action data of actions performed through the account. For each instance, the application manager 120 may input the account identifier and/or the historical action of the instance into both the machine learning model 122a and the machine learning model 122b (e.g., the same input into both machine learning models). The application manager 120 can also input a plurality of potential actions of the instance for the training data set into the machine learning models 122a and 122b. The application manager 120 may execute the machine learning models 122a and 122b based on the input. The executions can cause each of the machine learning models 122a and 122b to generate a recommendation identifying a set of potential actions.

The application manager 120 can use the set of potential actions of the recommendation generated by the machine learning model 122a as a ground truth to train the machine learning model 122b. For example, the application manager 120 can compare the set of potential actions of the recommendation generated by the machine learning model 122b to the set of potential actions of the recommendation generated by the machine learning model 122a, in some cases using a loss function. Based on the comparison, the application manager 120 can determine one or more differences between the two sets of potential actions. The application manager 120 can use back-propagation techniques on the machine learning model 122b (e.g., only the machine learning model 122b) based on the differences to adjust the weights and/or parameters of the machine learning model 122b. In doing so, the application manager 120 can adjust the weights and/or parameters of the machine learning model 122b such that the weights and/or parameters would cause the machine learning model 122b to generate recommendations of potential actions that are similar to recommendations generated by the machine learning model 122a. The application manager 120 can train the machine learning model 122b in this way for any number of instances of training data. Accordingly, the application manager 120 can train the machine learning model 122b, which may have already been trained according to the preferences of the user at the computing device 104, to accommodate the preferences of the user at the computing device 106. This method of training can enable the machine learning model 122b to generate more accurate recommendations and/or recommendations based on more complex relationships that may not be apparent to a model that was trained based only on selections by a single user.

The application manager 120 may use the machine learning model 122b to generate recommendations of sets of potential actions for the user accessing the user device 102. For example, the user can access the application 118 through an account that the user has with the application 118. In doing so, the user can select an option to access a web page or user interface that corresponds to an action that the user is seeking to complete. The user can provide an input (e.g., via an input/output device, such as a mouse, keyboard, or touch screen) into the web page or user interface that requests one or more potential actions. The application manager 120 can receive the input as a request for the one or more potential actions. Responsive to the request, the application manager 120 can retrieve the machine learning model 122b (e.g., the machine learning model 122b that has been trained based on recommendations by the machine learning model 122a) from memory. The application manager 120 can execute the machine learning model 122b using an account identifier of the user account associated with the user accessing the user device 102 to generate a recommendation comprising the one or more potential actions.

To generate the recommendation comprising the one or more potential actions, the application manager 120 may retrieve available potential actions from the remote computing device 108. For example, responsive to the request for the one or more potential actions, the application manager 120 can transmit a message to the remote computing device 108 for potential actions. In some cases, the request can include one or more attributes (e.g., action attributes) for the potential actions. In such cases, the application manager 120 can include the attributes in the request to the remote computing device 108.

For example, the application manager 120 may be configured to generate a user interface on the display of the user device 102. The user interface may be or include a set of options or elements that correspond to one or more different types of actions (e.g., action types) and/or attributes. A user accessing the user device 102 and the application 118 through an account associated with (e.g., owned by) the user can select one of the options or elements for a type of action. Responsive to the selection, the application manager 120 can transmit a request for potential actions to the remote computing device 108, in some cases including any selected attributes and/or the selected types of actions. The remote computing device 108 can receive the request and identify potential actions that the remote computing device 108 has stored in memory 114. The remote computing device 108 can identify potential actions that have attributes that match the attributes in the request. The remote computing device 108 can transmit any identified potential actions to the user device 102. The application manager 120 can receive the potential actions and use the potential actions as input into the machine learning model 122b to use to generate the recommendation of the set of potential actions requested by the user.

The application manager 120 may generate a feature vector to use as input into the machine learning model 122b to generate the recommendation of the set of potential actions. To do so, the application manager 120 may use the account identifier of the account through which the user is accessing the application 118. For example, the application manager 120 may query the action database 124 using the account identifier as a key to identify actions performed by or through the account. The application manager 120 may retrieve action data (e.g., time, date, value, code, location of completion, etc.) of all of the identified actions, of a defined number of the most recent identified actions, or of actions completed within an immediately previous defined time period (e.g., the previous year). The application manager 120 can include the retrieved action data in the feature vector. In another example, the application manager 120 may query the account database 126 using the account identifier as a key to identify account data (e.g., name, age, gender, time the account has been open, subscription information if the account is a subscription, etc.) of the account. The application manager 120 can include the retrieved account data in the feature vector. In some cases, the application manager 120 can include the account identifier itself in the feature vector. The application manager 120 can include any combination or permutation of such data in the feature vector. The application manager 120 can generate the feature vector with the data, in some cases by normalizing the values or converting the values into a format compatible with the machine learning model 122b (e.g., a numerical format using a table).

The application manager 120 can execute the machine learning model 122b using the feature vector as input with the potential actions received from the remote computing device 108. The execution of the machine learning model 122b can cause the machine learning model 122b to select a set of potential actions from the input potential actions to recommend to the user. The application manager 120 can generate a record (e.g., a matrix, a table, file, user interface, notification, alert, data structure, etc.) that includes the set of potential actions (e.g., identifications of the set of potential actions and/or any attributes of the potential actions) of the recommendation. The application manager 120 can present the record including the set of potential actions on a display (e.g., on a second user interface) of the user device 102 to the user.

The application manager 120 can facilitate completion of the selected potential action. For example, responsive to receiving the selection of the potential action, the application manager 120 can transmit a message to the remote computing device 108 indicating the potential action was selected. In some embodiments, the selection can indicate that no potential actions were selected from the set of potential actions. The message can include the identification or identifier of the account through which the potential action was selected, an identification of the potential action, and/or any attributes of the potential action. The remote computing device 108 can receive the message and transmit messages to any entities that correspond with (e.g., that offered) the potential action. The remote computing device 108 can update account data of the account to indicate that the user selected the potential action. Thus, the application manager 120 and the remote computing device 108 can facilitate completion of the selected potential action.

The application manager 120 can train the machine learning model 122b based on the selection of the potential action. For example, the application manager 120 can use back-propagation techniques on the machine learning model 122b by using the selected potential action as the ground truth and determining a difference between the selected potential action and the other potential actions that the machine learning model 122b selected to include in the recommendation. The application manager 120 can adjust the weights and/or parameters of the machine learning model 122b based on the difference to train the machine learning model 122b to generate recommendations that are more similar to the selected potential action. The application manager 120 can continue to train the machine learning model 122b in this way over time based on different requests to cause the machine learning model 122b to generate recommendations based on a blend of training from the users of the user device 102 and the computing devices 104 and 106. Thus, the application manager 120 can train the machine learning model 122b to generate recommendations based on more complex relationships between features.

In some cases, the application manager 120 can transmit the machine learning model 122b to another computing device. The application manager 120 can transmit the machine learning model 122b to the new computing device responsive to determining the machine learning model 122b is trained to at least an accuracy threshold by the user of the user device 102. In some cases, the application manager 120 can transmit (e.g., directly transmit or transmit through the remote computing device 108) the machine learning model 122b (e.g., after training the machine learning model 122b at the user device 102) to the computing device in response to receiving a request from the computing device and/or in response to receiving an input at a user interface presented at the user device 102, similar to how the computing devices 104 and/or 106 transmitted the machine learning models 122a and/or 122b to the user device 102. The computing device can receive the twice-trained (e.g., trained by two different users and/or by two different computing devices) machine learning model 122b and operate to generate recommendations of potential actions for a user of the computing device in a similar manner to the user device 102, as described herein. Thus, the system 100 can facilitate a chain of training a machine learning model at different computing devices, improving the accuracy and/or complexity with each training at a different computing device. In some embodiments, the computing devices can transmit copies of the machine learning model 122b back to each other after training locally. For instance, the computing device can continue training the machine learning model 122b locally based on selections by the user of the computing device and transmit the further trained machine learning model 122b back to the user device 102. The user device 102 may then use the thrice-trained (e.g., trained by three different users and/or by three different computing devices) machine learning model 122b to generate recommendations of potential actions.

In some cases, the application manager 120 may use machine learning models that are configured or trained to generate recommendations for specific types of actions. For example, a user may provide an input into a user interface to access a specific web page or user interface provided by the application 118 that corresponds to a specific type of action or for a recommendation for potential actions. The application manager 120 may identify the type of action of the input as a request and retrieve a machine learning model 122 from the machine learning models 122 that corresponds to the type of action. The machine learning model 122 may have been trained as described herein based on outputs of another machine learning model trained to generate recommendations of potential actions of the action type. The application manager 120 may include a type of action in a message to the remote computing device 108 and the remote computing device 108 may transmit potential actions of the type to the user device 102. The application manager 120 may execute the machine learning model 122 to select one or more potential actions received from the remote computing device 108 and generate a recommendation identifying the selected one or more potential actions. The application manager 120 may display the recommendation on a user interface displayed on the user device 102. The user accessing the user device 102 may select a potential action from the one or more potential actions and operate as described herein. By using machine learning models that are configured specific to individual action types, the user device 102 may further improve the accuracy of the recommendations that the application 118 generates.

In some embodiments, the application manager 120 may train the machine learning models 122a and 122b to generate recommendations of sets of different types of potential actions. For example, the machine learning model 122a can be configured to generate recommendations for sets of potential actions of a first type and the machine learning model 122b can be configured to generate recommendations for sets of potential actions of a second type. The application manager 120 can select which of the machine learning models 122a or 122b to use to generate recommendations based on the request (e.g., the application manager 120 can retrieve and use the machine learning model 122a responsive to a request for a recommendation for potential actions of the first type and retrieve and use the machine learning model 122 responsive to a request for a recommendation for potential actions of the second type). Each of the machine learning models 122a and 122b may be configured to receive the same types of inputs (e.g., the same or identical features of action data, account data, and/or an account identifier). The application manager 120 can train both of the machine learning models 122a and 122b based on the individual recommendations generated by the machine learning models 122a and 122b and the user selections from the recommendations. For instance, for each request for a recommendation, the application manager 120 can execute both of the machine learning models 122a and 122b to generate recommendations of sets of potential actions. The application manager 120 can identify the machine learning model 122 of the machine learning models 122a and 122b that is configured to generate recommendations for the type of action of the request and train the identified machine learning model 122a or 122b based on a selection by the user from the recommended set of potential actions generated by the machine learning model 122a or 122b. The application manager 120 can use the identified machine learning model 122a or 122b as the ground truth and train the other machine learning model 122a or 122b either based on the weights and parameters prior to the training performed based on the selection or based on the adjustment to the weights or parameters of the training made based on the selection. The application manager 120 can train each of the machine learning models 122a and 122b in this way over time to tune the machine learning models 122 based on the user's selections.

Furthermore, training the machine learning models 122a and 122b in this way can train or configure the machine learning models 122a and 122b to generate recommendations for sets of potential actions of new or different types of actions. For instance, the machine learning models 122a and 122b may have initially been configured to generate first and second types of recommendations, respectively. Training the machine learning models 122a and 122b based on recommendations of the other machine learning model 122a or 122b can enable or facilitate the machine learning models 122 to generate recommendations for the other type (e.g., the learned relationships for one type can provide new contextual information for the other or even another type). The machine learning models 122a and 122b may be trained and configured to generate recommendations for any type of actions.

In some embodiments, the application manager 120 can train the machine learning models 122 to generate recommendations for specific types of actions or to generate recommendations for multiple and potentially new type of actions. Doing so can increase the generalization ability of the machine learning models 122 to a group of types of actions (e.g., not just individual types of actions) and adapt the machine learning models 122 to the needs of new users while maintaining or improving performance over time (e.g., avoiding model drift failures in which the performance degrades over time, such as due to changing economic conditions, types of tasks/offers, user base, etc.). For example, the machine learning models 122a and 122b can be trained according to one of the embodiments described above. The user device 102 can transmit the machine learning models 122a and 122b to a new computing device. A user accessing the new computing device can train the machine learning models 122a and 122b based on recommendations generated by the machine learning models 122a and 122b locally on the new computing device and user selections by the user accessing the new computing device. Because the training can occur over time, the machine learning models 122a and 122b can account for changes in behavior by the user (e.g., changes in an environment in which the action takes place can influence a user's responsive to certain types of potential actions, such as offers). Accordingly, the machine learning models 122a and 122b can be resistive to concept drift. Furthermore, by training the machine learning models 122a and 122b in this way, the machine learning models 122a and 122b can be useful when the distribution of contextual features for the new user accessing the machine learning models 122a and 122b differs (e.g., significantly significantly) from the features of the users that initially trained the machine learning models 122a and 122b (e.g., the distribution of age, income, and/or location data of the users that previously trained the machine learning models 122a and 122b may differ significantly from the distribution of age, income, and location data of new users). Thus, the system can adapt to covariate shift that may be present in a changing and/or expanding user base.

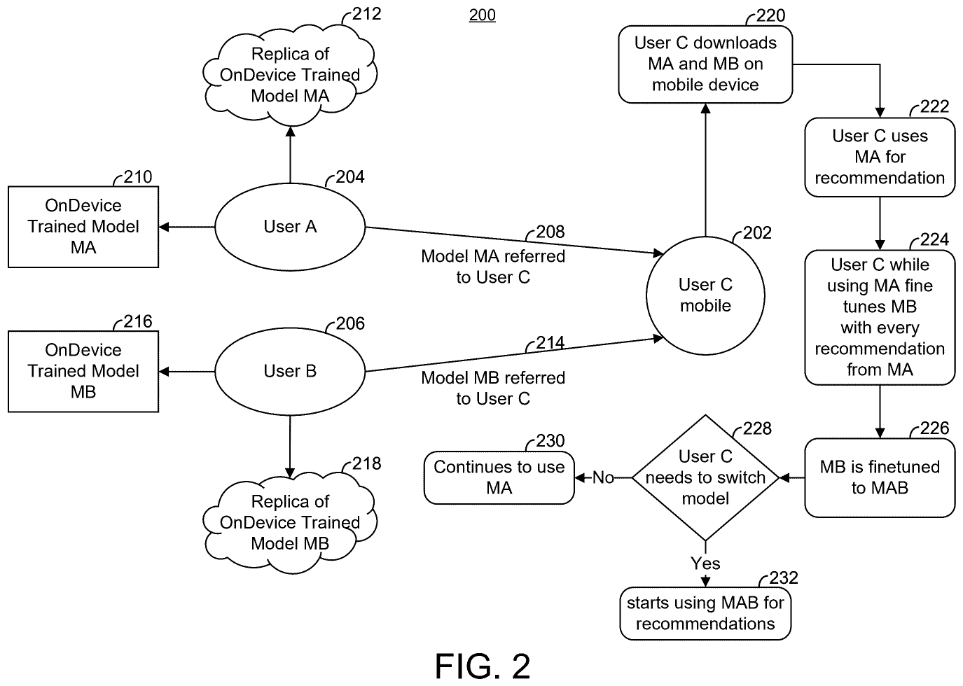

### FIG. 2

FIG. 2 illustrates a sequence diagram of a sequence 200 for collaborative machine learning model generation, in accordance with an implementation. The sequence 200 can be performed by the components of the system 100, shown and described with reference to FIG. 1. For example, individual operations of the sequence 200 can be performed by a user device 202, a computing device 204, and a computing device 206. The sequence 200 may include more or fewer operations, and the operations may be performed in any order.

In the sequence 200, at an operation 208, the computing device 204 of user A can transmit a trained machine learning model 210 to the user device 202 of user C. The computing device 204 of user A can train the machine learning model 210 to generate recommendations for potential actions (e.g., potential actions of a particular type or potential actions of multiple types) based on selections by or other actions of user A, who may be using the computing device 204 of user A during the training. The computing device 204 of user A can transmit a copy 212 of the machine learning model 210 to a cloud computer for storage and/or for training in a federated learning system. The computing device 204 of user A can transmit the machine learning model 210 (e.g., a copy of the machine learning model 210) to the user device 202 of user C. The computing device 204 of user A can transmit the machine learning model 210 to the user device 202 of user C after being trained based on the actions of user A, for example.

At an operation 214, the computing device 206 of user B can transmit a trained machine learning model 216 to the user device 202 of user C. The computing device 206 of user B can train the machine learning model 216 to generate recommendations for potential actions (e.g., potential actions of a particular type or potential actions of multiple types) based on selections by user B, who may be accessing the computing device 206 during the training. The computing device 206 of user B can transmit a copy 218 of the machine learning model 210 to the cloud computer (e.g., the same cloud computer to which the computing device 204 of user A transmitted the copy 212 of the machine learning model 210). The computing device 206 of user B can transmit the machine learning model 216 (e.g., a copy of the machine learning model 216) to the user device 202. The computing device 206 can transmit the machine learning model 216 to the user device 202 of user C after being trained based on actions of user B, for example.

The user device 202 of user C can receive the machine learning models 210 and 216 and, at an operation 220, download the machine learning models 210 and 216. The user device 202 of user C can download the machine learning models 210 and 216 into an application stored and executed on the user device 202 of user C that is configured to communicate with a remote computing device to access a financial platform provisioned by the remote computing device. At an operation 222, user C accessing the user device 202 may use the machine learning model 210 to generate recommendations for potential actions for user C to select. User C can cause the user device 202 to execute the machine learning model 210 to generate recommendations of sets of potential actions by making selections at user interfaces provided by the application executing on the user device 202. User C can select potential actions from the recommendations and the application can facilitate completion of the selected potential actions.

At an operation 224, the user device 202 of user C can use the recommendations generated by the machine learning model 210 to train the machine learning model 216. For example, while performing the operation 222 and executing the machine learning model 210 to generate recommendations of sets of potential actions, the user device 202 can use the same inputs (e.g., identical inputs) that were input into the machine learning model 210 to generate the recommendations as input into the machine learning model 216. The user device 202 can execute the machine learning model 216 based on the inputs to cause the machine learning model 216 to generate recommendations of sets of potential actions. The user device 202 can compare the sets of potential actions that were recommended by the two machine learning models 210 and 216 based on the same or common inputs to determine one or more differences between the recommendations. The user device 202 can use the sets of potential actions of recommendation generated by the machine learning model 210 as the ground truth and train the machine learning model 216 based on differences between the sets of potential actions of recommendations generated by the two machine learning models 210 and 216. The user device 202 can perform operations 222 and 224 over time as the user requests recommendations for sets of potential actions to train the machine learning model 216 to generate recommendations similar to the machine learning model 210. In doing so, at an operation 226, the user device 202 can train the machine learning model 216 to have weights that are biased to be a mixture of the weights of the machine learning models 210 and 216 that the user device 202 originally received.

At an operation 228, the user device 202 of user C determines whether to switch machine learning models to use to generate recommendations for potential actions. The user device 202 can do so by determining whether the user device 202 received an indication from user C to use the machine learning model 216 (e.g., the machine learning model 216 after training to be similar to the machine learning model 210). In some cases, the user device 202 can determine whether the machine learning model 216 is accurate above a threshold compared with the output recommendations by the machine learning model 210 to determine whether to switch machine learning models to use to generate recommendations. Responsive to determining no input to switch has been received or that the machine learning model 216 is not accurate above the accuracy threshold, at an operation 230, the user device 202 may continue to use the machine learning model 210 to generate recommendations of sets of potential actions and/or train the machine learning model 216 based on the recommendations. However, responsive to receiving an input indicating to switch and/or responsive to determining the machine learning model 216 is accurate above the accuracy threshold, at an operation 232, the user device 202 can initiate, start, or begin using the machine learning model 216 to generate recommendations of potential actions for the user C. In doing so, the user device 202 can continue to train the machine learning model 216 based on recommendations generated by the machine learning model 210 and/or train the machine learning model 216 based on selections from the sets of potential actions that the machine learning model 216 includes in recommendations.

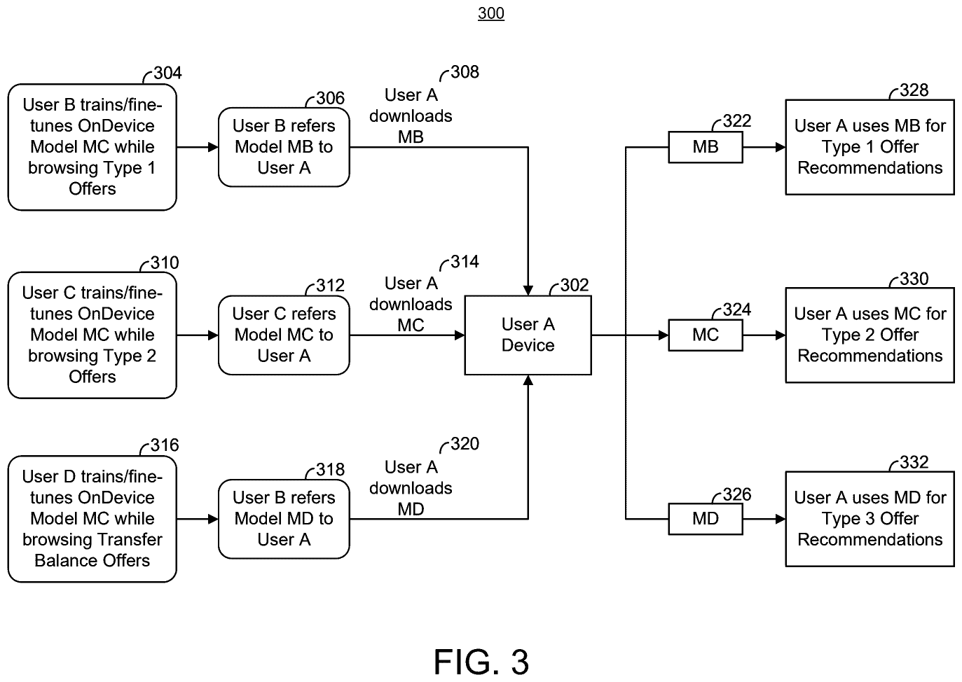

### FIG. 3

FIG. 3 illustrates a sequence diagram of a sequence 300 for collaborative machine learning model generation, in accordance with an implementation. The sequence 300 can be performed by the components of the system 100, shown and described with reference to FIG. 1. For example, individual operations of the sequence 300 can be performed by a user device 302 and other computing devices configured to execute machine learning models to generate recommendations of potential actions to users. The sequence 300 can involve storing shared machine learning models from different sources and configured to generate recommendations for different types of actions and using the stored machine learning models in response to requests form a user. The sequence 300 may include more or fewer operations, and the operations may be performed in any order.

In the sequence 300, a first computing device, user B can train or finetune a first machine learning model that is configured to generate recommendations for potential actions. User B can train or finetune the first machine learning model by requesting recommendations for potential actions and selecting potential actions to complete from the recommended actions. The first computing device can train the first machine learning model based on the selections over time to better personalize the recommendations for user B. At an operation 306, the first computing device can transmit the trained first machine learning model to the user device 302. At an operation 308, the user device 302 can receive the first machine learning model and download the first machine learning model into memory.

At an operation 310, at a second computing device, user C can train or finetune a second machine learning model that is configured to generate recommendations for potential actions to take. User C can train or finetune the second machine learning model by requesting recommendations for potential actions and selecting potential actions to complete from the recommended actions. The second computing device can train the second machine learning model based on the selections over time to better personalize the recommendations for user C. At an operation 312, the second computing device can transmit the trained second machine learning model to the user device 302. At an operation 314, the user device 302 can receive the second machine learning model and download the second machine learning model into memory.

At an operation 316, at a third computing device, user D can train or finetune a third machine learning model that is configured to generate recommendations for potential balance transfer offers (or any other action type). User D can train or finetune the third machine learning model by requesting recommendations for potential balance transfer offers and selecting potential balance transfer offers to complete from the recommended balance transfer offers. The third computing device can train the third machine learning model based on the selections over time to better personalize the recommendations for user D. At an operation 318, the third computing device can transmit the trained third machine learning model to the user device 302. At an operation 320, the user device 302 can receive the third machine learning model and download the third machine learning model into memory.

The user device 302 can access the different machine learning models based on actions performed or selections by user A when accessing the user device 302. For example, user A may provide an input to access a user interface or web page to view potential actions of specific action types. For example, user A may provide an input related to a specific type of action. Based on the input, the user device 302 can retrieve 322, 324, or 326 one of the machine learning models received and configured to generate recommendations of the requested type of action. At an operation 328, 330, or 332, the user device 302 can execute the retrieved machine learning model to generate a recommendation of potential actions of the requested type. The user device 302 can generate recommendations for any number of types of actions any number of times.

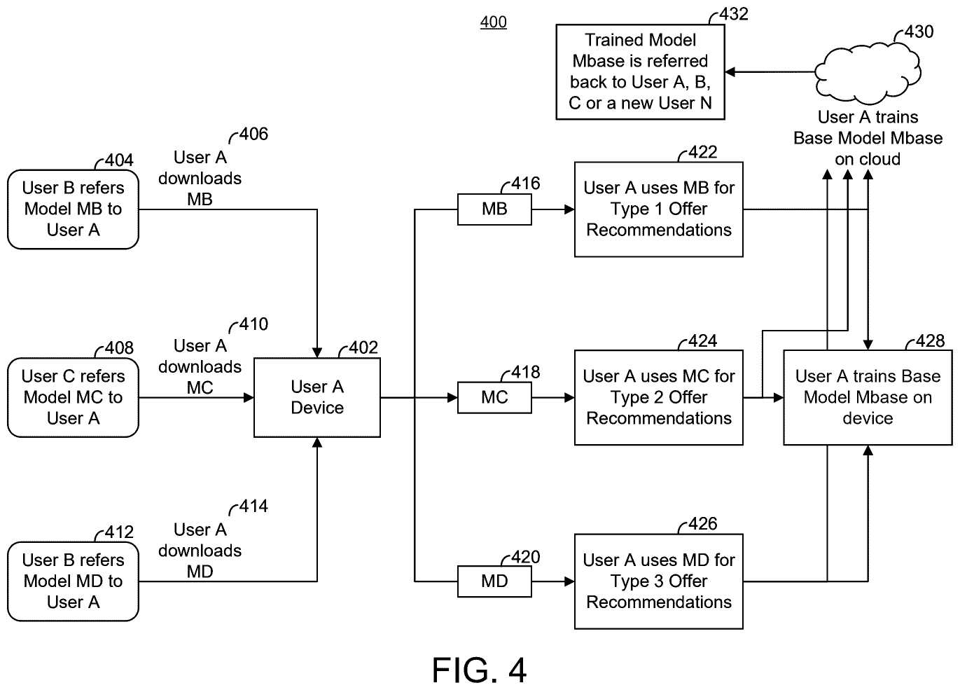

### FIG. 4

FIG. 4 illustrates a sequence diagram of a sequence 400 for collaborative machine learning model generation, in accordance with an implementation. The sequence 400 can be performed by the components of the system 100, shown and described with reference to FIG. 1. For example, individual operations of the sequence 400 can be performed by a user device 402 and other computing devices configured to execute machine learning models to generate recommendations of potential actions to users. The sequence 400 can involve performing the sequence 300 to receive and use machine learning models that are configured to generate recommendations for potential actions of different types from different computing devices and then train or generate a new or base machine learning model based on the recommendations from the different machine learning models. The sequence 400 may include more or fewer operations, and the operations may be performed in any order.

In the sequence 400, the user device 402 can perform operations 404-426 to receive and use machine learning models that are configured to generate recommendations for potential actions of different types from different computing devices. The user device 402 can perform the operations 404-426 in the same or a similar manner to the manner described with reference to operations 304-332. Each of the machine learning models may be configured to receive the same inputs but may be trained to have different weights and/or parameters to operate on the inputs to generate recommendations that are specific to the different types of actions. The user device 402 can perform the operations 416-426 over time to cause the machine learning models to generate recommendations for sets of potential actions. User A can select potential actions from the recommendations and then the user device 402 can train the respective machine learning models based on the selections by adjusting the weights and/or parameters of the machine learning models according to the selections.

As user A selects potential actions from the recommendations, at an operation 428, the user device 402 can train a base model based on the training of the other machine learning models. The base model can be configured to receive and process the same inputs as the machine learning models trained in operations 416-426. The user device 402 can be trained to generate recommendations of potential actions for the same types of potential actions.

The user device 402 can train the base model. The user device 402 can train the base model based on the weights and/or parameters of the machine learning models transferred to the user device 402 from other computing devices. In doing so, the user device 402 can instantiate the base model based on an average or median of the weights and/or parameters of the other machine learning models. The user device 402 can then adjust the weights and/or parameters of the base model based on changes in the weights and/or parameters of the other machine learning models, such as by the same or a proportional amount (e.g., the amount of change divided by the total number of machine learning models). The user device 402 may train the base model over time. The user device 402 can train the base model until determining that the base model generates recommendations with an accuracy at least that is at least equal to an accuracy threshold, which may be determined based on the percentage or number of selections of potential action the user makes from generated recommendations, in some cases compared with the number of instances in which the user does not make any selections from a recommendation, as may be how accuracy is determined as described herein throughout. Responsive to determining the base model is accurate to an accuracy threshold (e.g., a predetermined threshold), the user device 402 can use the base model to generate recommendations instead of the machine learning models that are configured to generate recommendations for specific types of actions. Accordingly, the user device 402 can train the base model based on more training data and more interactions between features to generate a more accurate and/or comprehensive model.

The user device 402 can transmit a copy of the base model to a cloud computing device 430. In some embodiments, the user device 402 can transmit updates to the local copy of the base model to the cloud computing device 430 as the user device trains the local copy of the base model. The cloud computing device 430 can update the base model stored at the cloud computing device as the cloud computing device 430 receives the updates. At an operation 432, the cloud computing device 30 can transmit a copy of the trained base model to the computing devices that transmitted the original machine learning models to the user device and/or any other computing devices, either automatically upon updating the base model or responsive to receiving a request for the base model from the respective computing devices.

In a non-limiting example, the user device 402 can receive a number N of previously trained machine learning models from a set of N computing devices (e.g., each computing device can locally train and send the user device 402 a different machine learning model to the user device 402). Each model can be configured to generate recommendations for potential actions of a specific type (e.g., a different type). While using the received machine learning models, user A accessing the user device 402 can train a base model, Mbase, stored locally on the user device 402 based on user actions and recommendations of the different machine learning models as input to generate a more sophisticated model. The user device 402 can transmit the trained base model to the computing devices that provided the initial machine learning model and/or to computing devices that connect with the system. Training the base model in this case can enable or facilitate the base model providing more relevant potential actions to users. In some embodiments, the training can facilitate the base model learning multiple user habits while trading stocks in a single refined model. In some embodiments, the training can facilitate the base model having a better understanding of fraudulent actions from multiple users' behavior.

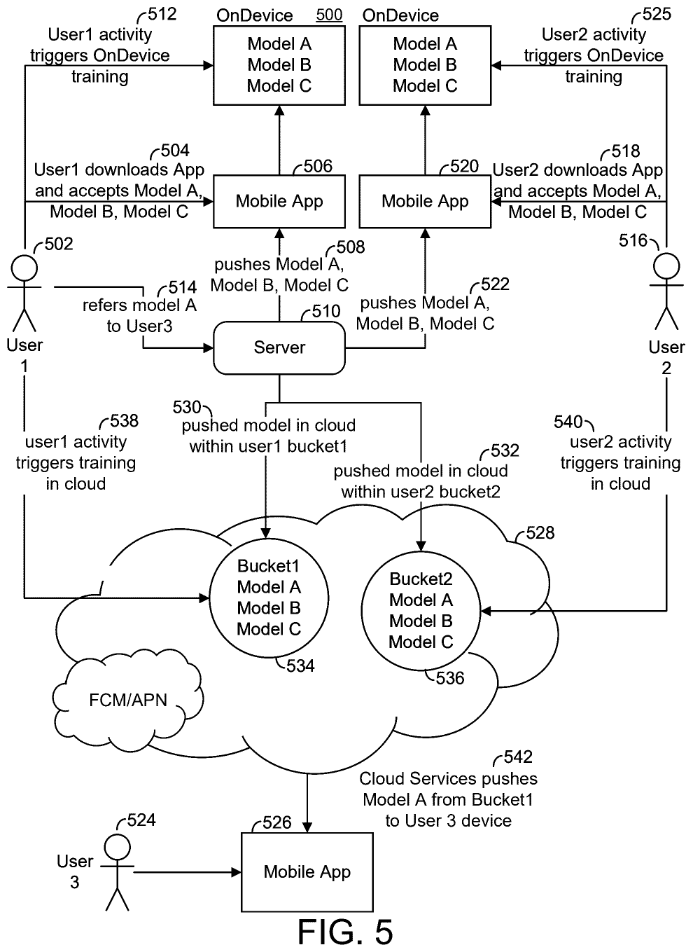

### FIG. 5

FIG. 5 illustrates a sequence diagram of a sequence 500 for collaborative machine learning model generation, in accordance with an implementation. The sequence 500 can be performed by the components of the system 100, shown and described with reference to FIG. 1. For example, individual operations of the sequence 500 can be performed by a user device 402 and other computing devices configured to execute machine learning models to generate recommendations of potential actions to users. The sequence 500 may include more or fewer operations, and the operations may be performed in any order.

In the sequence 500, a user device 502 can download 504 machine learning models A, B, and C that are each configured to generate recommendations for potential action to an application 506 stored and/or executing on the user device 502. The user device 502 can receive 508 the machine learning models A, B, and C from a server 510. The user device 502 can train 512 one or more of the machine learning models A, B, or C based on selections of potential actions that a user accessing the user device 502 makes based on recommendations from the machine learning models A, B, and C. The user device 502 can transmit 514 the machine learning model A to the server 510, such as after each instance in which the user device 502 trains the machine learning model A, responsive to a request from the server 510, and/or responsive to a request from a user device 524 stored and/or executing an application 526.

Similarly, a user device 516 can download 518 machine learning models A, B, and C to an application 520 stored and/or executing on the user device 516. The user device 516 can receive 522 the machine learning models A, B, and C from the server 510. The user device 516 can train 525 one or more of the machine learning models A, B, or C based on selections of potential actions that a user accessing the user device 516 makes based on recommendations from the machine learning models A, B, and C. The user device 516 can transmit the machine learning model A to the server 510, such as after each instance in which the user device 516 trains the machine learning model A.

The server 510 can transmit the machine learning models A, B, and/or C in a cloud computing system 528. For example, the server 510 can transmit the machine learning models A, B, and/or C to the cloud computing system 528 after receiving the machine learning models A, B, and/or C from the user devices 502 and/or 516. In some embodiments, the server 510 can transmit updates (e.g., changes in the weights and/or parameters) to the machine learning models A, B, and/or C to the cloud computing system 528 for each update to the respective models. The cloud computing system 528 can store the copies of the machine learning models received from the user devices 502 and 516 in logically and/or physically separate buckets 534 and 536 such that the cloud computing system has different versions of the machine learning models A, B, and C stored that have been trained by specific users and/or specific user devices. The user devices 502 and/or 516 can train 538 and/or 540 the corresponding buckets 534 and/or 536 of machine learning models by transmitting any updates to the locally stored versions of the machine learning models to the cloud computing system 528.

The cloud computing system 528 can transmit 542 the machine learning model A to the application 526 executing on the user device 524. The cloud computing system 528 can transmit the machine learning model A to the application 526 in response to the request from application 526 and/or responsive to an update to the machine learning model A as stored in the cloud computing system 528 (e.g., an update to a copy of the machine learning model A flagged to propagate to all computing devices and/or only to specific computing devices). The sequence 500 can facilitate a user-to-server exchange of parameters and/or weights of machine learning models. Thus, the sequence 500 can facilitate user-to-user referrals through the cloud computing system 528 and/or the server 510.

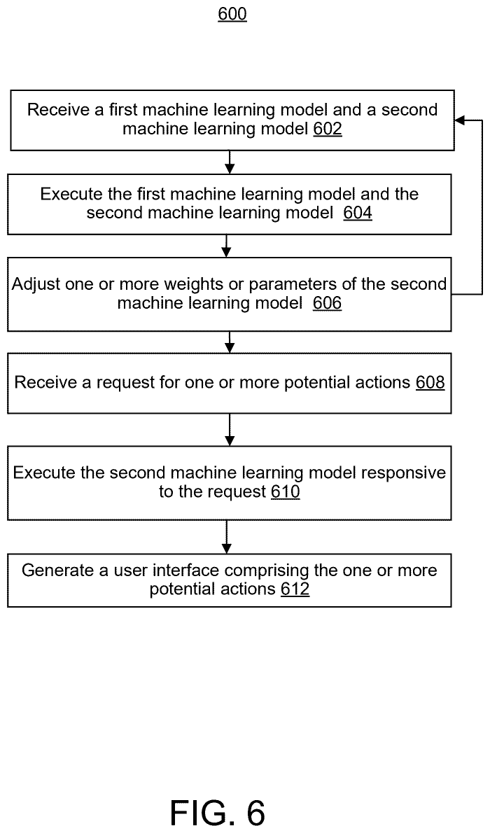

### FIG. 6

FIG. 6 illustrates an example method for collaborative machine learning model generation, in accordance with an implementation. The method 600 can be performed by a data processing system (e.g., the user device 102, the computing device 106, and/or the computing device 106, each shown and described with reference to FIG. 1, a server system, etc.). The method 600 may include more or fewer operations and the operations may be performed in any order. Performance of the method 600 may enable the data processing system to collaboratively generate, train, and fine tune machine learning models to generate recommendations of sets of potential actions.

In the method 600, at an operation 602, the data processing system receives a first machine learning model and a second machine learning model. The first machine learning model can be configured to generate recommendations that each include a set of potential actions that a user can select to complete. The second machine learning model can also be configured to generate recommendations that each include a set of potential actions that the user can select to complete. The first and second machine learning models can be configured to generate recommendations for sets of potential actions of the same type or of different types. The data processing system can receive the first and second machine learning models using an application. The data processing system can receive the first machine learning model from a first computing device and the second machine learning model from a second computing device. The first and second computing devices can transmit the first and second machine learning models to the data processing system in response to a request from the data processing system and/or in response to receiving inputs from users accessing the respective first and second computing devices.

The first computing device can train the first machine learning model, and the second computing device can train the second machine learning model. The computing devices can train the respective machine learning models based on selections and/or actions that users take at the computing devices. For example, a user may access an application executing on the first computing device via a user interface presented on the first computing device. Via the user interface, the user may provide inputs that include requests for sets of potential actions that the user can perform via their respective accounts with the application. The first computing device may receive the requests and request potential actions from a remote computing device (e.g., a remote server). The first computing device may execute the first computing device using historical action data of the user (e.g., based on an account identifier of the user's account with the application) as input to select a set of potential actions from the received potential actions from the remote computing device. The first machine learning model may generate a recommendation identifying the selected set of potential actions and present the set of potential actions on the user interface to the user. The user may select a potential action from the set of potential actions and the first computing device may train the first machine learning model based on the selection (e.g., using back-propagation techniques). The first computing device can train the first machine learning model in this way over time as the user requests sets of potential actions, thus, the first computing device can train the first machine learning model to be configured to make more accurate recommendations that are specific to the user. The second computing device can similarly train the second machine learning model based on recommendations made by the second machine learning model.

At an operation 604, the data processing system executes the first machine learning model and the second machine learning model. The data processing system can execute the first machine learning model based on a user input by a user accessing the data processing system. For example, the user can input a request for potential actions into a form, user interface, and/or web page being presented by the data processing system. The request can be a request for potential actions similar to the requests received at the first and/or second computing devices. Responsive to receiving the request, the data processing system can use an account identifier of the account through which the user provided the input request to retrieve historical action data of actions performed by the user and/or account data of the user. The data processing system can also retrieve potential actions from the remote computing device responsive to the request. The data processing system can input the historical action data and/or account data into each of the first machine learning model and the second machine learning model and separately execute the first machine learning model and the second machine learning model. Based on the executions, the first and second machine learning models can each select a set of potential actions from the potential actions the data processing system retrieved from the remote computing device. The first and second machine learning models may each generate a recommendation including the set of potential actions that the respective machine learning models selected.

The data processing system can use the recommendations generated by the first and second machine learning models to train the second machine learning model. For example, at an operation 606, the data processing system adjusts one or more weights or parameters of the second machine learning model. The data processing system can adjust the weights or parameters of the second machine learning model based on a difference between the sets of potential actions included in the recommendations generated by the two machine learning models. For instance, the data processing system can use the recommendation generated by the first machine learning model as a ground truth to train the second machine learning model. The data processing system can compare the recommendation including the set of potential actions from the first machine learning model with the recommendation including the set of potential actions from the second machine learning model to determine a difference (e.g., one or more differences) between the two sets of potential actions. The data processing system can use back-propagation techniques on the second machine learning model based on the difference, thus causing the weights and/or parameters of the second machine learning model to be similar to the weights and/or parameters of the first machine learning model. The data processing system can repeat operations 602-606 any number of times to integrate the weights and/or parameters of the two machine learning models together such that the second machine learning model can process or identify more complex relationships in the action data that may not have been apparent based only on the training by the user of the second computing device that initially provided the inputs to train the second machine learning model. In some cases, the data processing system can use the first machine learning model to generate recommendations of sets of potential actions until the second machine learning model is sufficiently trained (e.g., accurate at least to an accuracy threshold compared with the outputs of the first machine learning model, such as based on the number of matching output potential actions from the first machine learning model and the second machine learning model) and/or the data processing system receives an input (e.g., a user input or an input from another computing device) indicating to begin using the second machine learning model to generate recommendations.

At an operation 608, the data processing system receives a request for one or more potential actions. The request can be or include a request for a potential type of action, in some embodiments. The data processing system can receive the request for one or more potential actions as an input from a user interface generated and presented to the user of the data processing system by the application executed by the data processing system. For instance, the data processing system can receive the request when the user accessing the application selects an element (e.g., an element from a drop-down menu indicating types of actions) from a user interface or selects a form or link provided by the application on a user interface (e.g., a first user interface) that is configured to cause the application to provide a new user interface (e.g., a second user interface) with potential actions from which the user can select.

At an operation 610, the data processing system executes the second machine learning model. The data processing system can execute the second machine learning model responsive to the request (e.g., responsive to receiving the request). The data processing system can execute the second machine learning model instead of the first machine learning model responsive to determining a flag has been associated with the second machine learning model in memory, such as based on a user input or responsive to the second machine learning model being accurate to a threshold compared with the first machine learning model. In one example, responsive to the request, the data processing system can receive potential actions from the remote computing device, in some cases potential actions that correspond with a type and/or one or more attributes indicated in the request. The data processing system can retrieve historical action data of actions performed by the user's account (e.g., a defined number of the most recently completed actions or actions performed within a defined time period (e.g., a time period immediately previous to the current time)) using the account identifier of the account. The data processing system can input the retrieved historical action data into the second machine learning model and execute the second machine learning model to cause the second machine learning model to select a set of potential actions from the potential actions retrieved from the remote computing device. The selected set of potential actions can be identified in a recommendation (e.g., an identification of the set of potential actions, such as a list of the selected set of potential actions).

At an operation 612, the data processing system generates a user interface (e.g., a second user interface) that includes the one or more potential actions. The data processing system can generate the user interface by updating the user interface from which the data processing system received the request for potential actions. The data processing system can generate a record comprising the selected set of potential actions and present the record or the set of potential actions on the user interface. The data processing system can present the updated user interface on the display of the data processing system.

After presenting the updated user interface on the display of the data processing system, the user can view and select one action of the set of potential actions. Responsive to the selection, the data processing system can transmit an indication or identification of the selected potential action to the remote computing device. The remote computing device may complete the action or otherwise store an indication in the account through which the user selected the potential action indicating that the potential action was selected. The remote computing device can monitor the selected potential action to complete the potential action for the account.

In one aspect, the present disclosure describes a system. The system can include one or more processors of a client device. The one or more processors can be configured by machine-readable instructions stored in memory, wherein, upon execution, the machine-readable instructions cause the one or more processors to receive, via an application executed by the one or more processors, a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device; execute, via the application, the first machine learning model to generate a first recommendation for a set of potential actions and the second machine learning model to generate a second recommendation for a set potential actions; adjust, via the application, one or more weights or parameters of the second machine learning model to train the second machine learning model based on a difference between the first recommendation for the set of potential action generated by the first machine learning model and the second recommendation for the set of potential action generated by the second machine learning model; receive, via the application, a request for one or more potential actions at a first user interface presented on a display of the client device; responsive to the request, execute, via the application, the trained second machine learning model using an account identifier of a user account being used to access the application to generate the one or more potential actions; and generate, via the application, a second user interface on the display of the client device comprising the one or more potential actions.

In another aspect, the present disclosure describes a method. The method can include receiving, by one or more processors of a client device via an application, a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device; executing, by the one or more processors via the application, the first machine learning model to generate a first recommendation for a potential actions and the second machine learning model to generate a second recommendation for a set potential actions; adjusting, by the one or more processors via the application, one or more weights or parameters of the second machine learning model to train the second machine learning model based on a difference between the first recommendation for the set of potential action generated by the first machine learning model and the second recommendation for the set of potential action generated by the second machine learning model; receiving, by the one or more processors via the application, a request for one or more potential actions at a first user interface presented on a display of the client device; responsive to the request, executing, by the one or more processors via the application, the trained second machine learning model using an account identifier of a user account being used to access the application to generate the one or more potential actions; and generating, by the one or more processors via the application, a second user interface on the display of the client device comprising the one or more potential actions.

In another aspect, the present disclosure describes non-transitory computer-readable media, comprising instructions that, when executed by one or more processors, cause the one or more processors to receive a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device; execute the first machine learning model to generate a first recommendation for a set of potential actions and the second machine learning model to generate a second recommendation for a set of potential actions; adjust one or more weights or parameters of the second machine learning model to train the second machine learning model based on a difference between the first recommendation for the set of potential action generated by the first machine learning model and the second recommendation for the set of potential action generated by the second machine learning model; receive a request for one or more potential actions at a first user interface presented on a display of a client device; responsive to the request, execute the trained second machine learning model using an account identifier of a user account being used to access an application of the instructions to generate the one or more potential actions; and generate a second user interface on the display of the client device comprising the one or more potential actions.

The actions described herein can be any of a variety of different kinds of actions. In an example, the action is an input received at a device from a user. An action can be something that is performed as a result of an input from a user. An action can be something done by the user that is detected by the device. In an example, actions are things that can be done with respect to applications or functionality provided by a user device or an accessory of the device. For instance, action can be the activation of a feature or function of the device or software thereof. In addition, or instead, the action can be a feature or function of another device, software, capability, or service of another device or entity accessible through the user device. In some examples, the actions are independent of the user device or are performed independent of a device. Example actions or types include a communication action (e.g., sending a message to another device or person), a transaction (e.g., a financial transaction, such as a loan, credit card offering, balance transfer, interaction with a transaction processing system, such as an automated clearinghouse, or another financial transaction), a purchase action (e.g., acting on an advertisement, visiting a store, interacting with a point-of-sale system), an entertainment action (e.g., consuming certain kinds of textual, visual, auditory, or other content), a treatment action (e.g., consuming medicine, taking a therapy action, measuring a health parameter, or another action), a fitness action (e.g., starting a workout) another action, or combinations thereof.

### Large Language Models and Generative Artificial Intelligence

Large language models can be used to implement or enhance aspects described herein. As discussed above, replays, logs, or other data of user interactions with the digital experience can be captured. Such data can be provided as input to a large language model with a prompt to summarize what occurred. Such a summary can be provided as part of the remediation (e.g., to developers to better understand the problem). Further, the large language model can be prompted to identify designs or other changes that may be implemented to address the struggle. In addition to or instead of designs, the large language model may be configured to (e.g., with appropriate prompts and contacts) generate code or instructions (or changes to code or instructions) that address the struggle. A large language model may be used to generate user-specific and struggle-specific messages to the user (e.g., in relation to the above communications).

### Latent Features for Network Optimization in Federated Operations

Operations to train intelligent predictive models are a critical step in ensuring effective use of such predictive models. In the case of a predictive model that relies on activity performed via one or more applications executing on a client device, a computer system may train this predictive model using data provided by the one or more applications. In many cases, a computer system may refine the predictive model by using latent features, where a latent feature may be determined from other feature values. However, detecting latent features in a data set involving multiple devices with multiple users that may use an application with dramatically different goals can become a very challenging endeavor. In many cases, the ability to detect latent features may be hampered by the computational limitations of a computer system.

A computer implementing the systems and methods described herein can address these limitations on the use of latent features for refining a machine learning model and other technical deficiencies. A computer system may reduce centralized computing load during federated learning operations by using different types of latent features provided by different devices. The computer system may send a machine learning model (e.g., the same version of a machine learning model) to a first and second set of client devices. In some embodiments, the machine learning model is trained to ingest features indicating user interactions with an application to output predictions about future actions that the user may take or classify the user with a category that can initiate or trigger one or more downstream operations.

After receiving the machine learning model, the first and second sets of user devices may respectively determine different latent features that are important or relevant to predictions that the machine learning model generates. The sets of user devices can detect such differences based on how an application executing on the respective sets of user devices are used or differences in how latent features are defined by the sets of user devices. The first and second sets of user devices may result in drastically different types of latent features and corresponding latent feature values for the respective first and second sets of devices. For example, the first set of client devices may detect the importance and values for a first set of latent features. The first set of client devices may do so, for example, by using randomly (e.g., pseudo-randomly) generated latent features and testing which the generated latent features have the greatest ability to predict an outcome. In some embodiments, using the first set of client devices to evaluate the importance of a large number of latent features to prioritize or otherwise identify the first set of latent features may reduce the total amount of computational resources a central server would need to consume to independently find the same set of latent features. The second set of client devices may detect the importance and values for a second set of latent features using similar operations. In some embodiments, the application on a device may generate (e.g., randomly generate) latent features by adding feature values, multiplying feature values, or applying a delta function to the feature values.

The computer system may retrieve these latent feature values from these sets of client devices and use them to train the machine learning model to produce a refined machine learning model. A computer system may train a refined machine learning model to use latent features as inputs and produce an output usable for a downstream action. For example, some computer system may obtain first latent feature values from a first device assigned to a first user and a second latent feature values from a second device assigned to a second user, where both first and second users are assigned to a same user category. The computer system may then use the latent feature values to refine a machine learning model by provisioning resources for a training operation that trains a machine learning model to produce predictions about users of this user category based the latent feature values.

The outputs of these refined machine learning models may cause various types of downstream actions. Such actions may include updates to a user record or other record related to a device providing data used by a refined machine learning model. For example, after refining a machine learning model, a server system may provide additional latent feature values derived from client data to the refined machine learning model to produce a prediction. In response to receiving a particular prediction from the refined machine learning model, the server system may update a record related to a user of the client device or related to the device itself. Furthermore, some embodiments may indicate feature values to a user to indicate which values are triggering the downstream update action, such as feature values stored in the record. For example, the computer system may generate a message indicating additional record values of a record related to the latent feature values and send the message to a control system that would lock the record from further operations.

In one example, the aforementioned system may concretely improve the robustness and accuracy of federated learning operations by increasing the number of latent features available to train a refined machine learning model. Furthermore, by permitting the use of latent feature values, some embodiments may produce models that rely on fewer input variables to generate predictions, thereby reducing the bandwidth of a federated network that uses such models. A computer system may then use latent features as inputs for the refined machine learning model to predict outputs used to initialize one or more downstream operations. By using client devices to pre-filter latent features before investigating them on the server end, operations to use a latent-feature-value-trained machine learning model can be accelerated and network bandwidth can be conserved. For example, some embodiments may update a machine learning model to use latent feature values to predict whether a device has been compromised or whether an application should receive an update. Downstream operations may include sending a message to a user of the device indicating a device security breach, updating an application, or deactivating the application used to access the user's record. Such operations can improve network performance of a federated system and model accuracy.

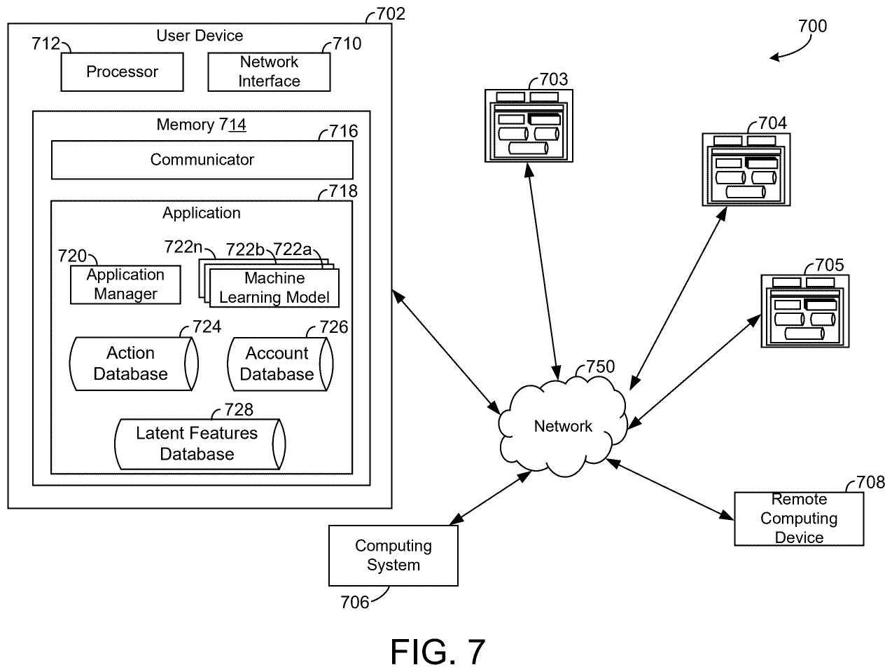

For example, FIG. 7 illustrates an example system for refining a machine learning model with different sets of latent features, in accordance with an implementation. In brief overview, the system 700 can support a federated learning model and includes user devices 702-705 and a computing system 706, where the computing system 706 may include one or more computing devices (e.g., similar to or the same as the computing device 104 or the computing device 106). The computing system 706 may include one or more non-transitory, machine-readable media that stores program instructions that, when executed, causes processors of the computing system 706 or other processors to perform one or more operations described in this disclosure.

Each respective user device of the user devices 702-705 may be similar to the user device 102 of FIG. 1 and may perform operations similar to or the same as those described for the user device 102. Furthermore, each respective device of the computing system 706 may be similar to or the same as the computing device 106 and may perform operations similar to or the same as those described by the computing device 106. In some embodiments, the computing system 706 may include multiple computing devices, a cloud computing system, etc. The user devices 702-705 and the computing system 706 can each include one or more aspects or features described elsewhere herein, such as in reference to the computing environment 1500 of FIG. 15. The user devices 702-705, the computing system 706, and/or the remote computing device 708 can include or execute on one or more processors or computing devices and/or communicate via a network 750, which may be similar to or the same as the network 105. Users can access a platform provided by the remote computing device 708 through the user device 702 or the computing system 706 to view potential actions requested by the users and/or otherwise manage an account the user has with an institution that manages an application stored locally on each of the user devices 702-705, the computing system 706, or other computing devices.

In one example, a user of the computing system 706 can provide an input into the computing system 706 requesting one or more potential actions of a particular type. The computing system 706 can execute an application to retrieve multiple potential actions of the requested type from the remote computing device 708. The remote computing device 708 can transmit potential actions of the requested type to the computing system 706. The computing system 706 can execute a machine learning model to select one or more potential actions, categorize a user with one or more categories, predict a future user action, etc. For example, the computing system 706 may select a potential action from a set of received potential actions and present the selected one or more potential actions to the user using feature values provided by client devices (e.g., the user devices 702-705). The user can select one of the presented potential actions. In response to the user's selection, the computing system 706 can transmit the selected potential action to the remote computing device 708 to complete through the user's account with the platform provided by the remote computing device 708.

In some embodiments, one or more of the user devices 702-705 and computing system 706 can act in a federated manner by training or refining a machine learning model based on actions or potential actions to provide predictions or categories. Such predictions or categories may be useful for effectuating downstream activity. Such downstream activities may include selecting additional potential actions for display, locking a record to prevent transactions, etc. The computing system 706 can transmit the machine learning models to the user device 702 directly through the network 750 and/or through the remote computing device 708. The user device 702 can receive the machine learning models and store the machine learning models in memory.

Each device of the user devices 702-705 may include some or all of the components shown for the user device 702. The user device 702 may include a network interface 710 (which may be similar to or the same as the network interface 110 of FIG. 1), a set of processors 712 (which may be similar to or the same as the processor 112 of FIG. 1), and/or memory 714 (which may be similar to or the same as the memory 114 of FIG. 1). The user device 702 may communicate with the computing system 706 and/or other computing devices described in this disclosure. The set of processors 712 may execute computer code or modules stored in memory 714 to facilitate the activities described herein.

The memory 714 may include a communicator 716 (which may be similar to or the same as the communicator 116 of FIG. 1) and an application 718 (which may be similar to or the same as the application 118 of FIG. 1). The application 718 can include an application manager 720, machine learning models 722a-n (individually machine learning model 722, and, in groups, machine learning models 722), an action database 724, an account database 726, and/or a latent features database 728.

In brief overview, each of the user devices 702-705 may receive one or more machine learning models from the computing system 706 and use this local model to help train a server-side model in a federated manner that reduces network traffic. For example, the communicator 716 may receive a set of machine learning models that are then executed by the user device 702. The user device 702 may determine one or more latent features that are then sent to the computing system 706. The computing system 706 may use the different latent feature values and their corresponding latent feature types to generate or refine a machine learning model to make more accurate predictions. By relying on individual devices to identify latent features and provide corresponding latent feature values, the computing system 706 may significantly reduce the amount of computation needed to generate accurate machine learning models. Moreover, because these latent features will only be calculated by devices, some latent features that would otherwise be based on unusable private data may be relied upon to provide a more accurate machine learning model. Additionally, because latent feature values may require less data than the input data used to produce them, some embodiments may reduce the overall bandwidth consumption of a federated system. For example, a model stored in the computing system 706 that uses only a latent feature value that is a sum of five other values would need only the latent feature value itself to be sent, thereby conserving the bandwidth required for a client device to send input data for the model.

The action database 724 may be similar to or the same as the action database 124. For example, the action database 724 may include a relational database or a graphical database and include action data for actions performed by different accounts. The user device 702 can store data for actions in the action database 724 over time. The account database 726 may be similar to or the same as the account database 126 and may include a database for different accounts. The communicator 716 may be similar to or the same as the communicator 116. For example, the communicator 716 can establish a connection with the computing system 706. Furthermore, the application 718 comprises programmable instructions that, upon execution, may cause the set of processors 712 to perform one or more operations similar to or the same as those described as being performed by or performable by the processor 112 or other operations described in this disclosure. For example, the application 718 can be an API and be part of or include the communicator 716.

In some cases, the application 718 can use machine learning models or machine learning techniques to select a set of potential actions to include in a user interface and present the user interface on the display. A user can select a potential action from the set of potential actions, and the application 718 can transmit the selection (e.g., an identification of the selected potential action) to the remote computing device 708. In some embodiments, the application may ingest an initial set of features indicating user interactions with potential actions to output one or more learning model outputs. Furthermore, the application 718 may generate latent features that are stored in the latent features database 728, select one or more latent features to deliver to a server (e.g. the computing system 706), and send these one or more latent features to the server.

In some embodiments, a server system may send a refined model to one or more client devices. For example, after updating a machine learning model based on latent feature values received from the user devices 702-705, the computing system 706 may send the refined model to one or more devices of the user devices 702-705. In some embodiments, a device that receives this refined model may then directly use the model to make one or more predictions or classifications. For example, the computing system 706 may send a refined model to the user device 702, where the refined model on the user device 702 may ingest a first latent feature value and a second latent feature value as inputs to determine whether a user of the user device 702 is a viable candidate to receive a notification. In some embodiments, after being provided with the refined model, a client device may delete an existing machine learning model and replace the deleted model with the existing machine learning model. For example, the computing system 706 may send a refined model to the user device 702. The refined model may predict whether a user is committing fraudulent activity based on a first latent feature and a second latent feature. The user device 702 may then delete a local machine learning model that predicts whether the user is committing fraudulent activity and replace it with the refined model instead.

In some embodiments, the computing system 706 may receive a new set of latent feature values from the user devices 702-705 after refining an initial machine learning model to produce a refined machine learning model. For example, the user device 702 and the user device 703 may provide feature values of the first latent feature type to the computing system 706, and the user device 704 and the user device 705 may provide feature values of the second latent feature type to the computing system 706. The computing system 706 may provide these new feature values to the refined machine learning model as inputs and directly determine predicted outputs from this refined machine learning model.

After refining a machine learning model trained to detect whether a user is erroneously recording information, the computing system 706 may receive a first new set of latent feature values from a first set of devices that includes the user device 702 and the user device 703. For example, this first new set of latent feature values may correspond with a latent feature defined as a ratio of measured initial feature values (e.g., a ratio of the amount of time that an application is open relative to the clicks or taps in a data entry form). Additionally, the computing system 706 may receive a second new set of latent feature values from the second set of devices that includes the user device 704 and the user device 705. For example, the second set of latent feature values may correspond with a second latent feature defined as the sum of other initial feature values (e.g., a sum of the number of times a user activates a first action and the number of times the user activates a second action). The computing system 706 may then provide a model output based on these new latent feature values, where the model output may indicate a likelihood of fraud or innocent error and, based on the model output, determine whether to lock a user account record for the user. Based on a model output, the computing system 706 may then send a candidate message to effectuate a change to a record value of a record or indicate the record value of the record associated with the user. For example, the computing system 706 may send a candidate message indicating an account amount representing a loan to a user in response to a determination that a model output satisfies one or more alert criteria (e.g., the model output is a category value that matches with a criteria category indicating an alert status).

In some embodiments, one or more devices of the user devices 702-705 may store and use multiple machine learning models that use different feature values as inputs and may generate latent features based on these different sets of inputs. For example, the user device 702 may use a first machine learning model 722a to predict whether to display a user interface element providing an option to initiate a data session with a chatbot and use a second machine learning model 722b to predict whether to flag a user as performing actions indicative of being a fraud victim. The first machine learning model 722a may use a first initial set of features as a first set of inputs, where the first initial set of features may include a count of times that a user interacts with a specified set of UI elements of the application 718 without executing one of a specific type of database transactions (e.g., a transfer, a loan amount investigation, etc.). Additionally, the second machine learning model 722b may use a second initial set of features as a second set of inputs, where the second initial set of features may include a duration that an application is active and open on the user device 702 and an amount of data transferred by the application 718 in that duration.

In some embodiments, the application 718 may determine a latent feature based on a first feature value of the first initial set of feature values and a second feature value of the second initial set of feature values. For example, the application 718 may use a rules engine that applies a set of criteria to determine a latent feature value based on the first and second initial sets of feature values. The rules engine may use a set of thresholds to determine the latent feature value, such as by comparing the first initial set of feature values with a first set of thresholds. For example, the application 718 may compare the count of times that the user interacted with the specified set of UI elements with a count threshold to determine whether the count exceeds the first threshold. Furthermore, the rules engine may cause the application 718 to compare the duration that the application was active with a duration threshold to determine whether the duration exceeds the duration threshold. Based on a determination that the count threshold and the duration thresholds are exceeded, the rules engine may then set a latent feature value to be “REAL” in lieu of other feature values. It should be understood that other types of latent features may be determined from the sets of inputs for different machine learning models using other methods.

In some embodiments, one or more devices of the user devices 702-705 may send a set of feature values to the computing system 706 or another server system based on one or more thresholds. For example, the user device 702 may send a feature value to the computing system 706 in response to a determination that the feature value exceeds a threshold. For example, one or more devices of the user devices 702-705 may count user actions and send data from a client device based on activity frequency indicating the frequency of those actions, wherein the activity frequency may then be compared with a threshold. In some embodiments, the application manager 720 may count the number of interactions that a user has with a user interface of the application 718. In some embodiments, this number of interactions may be restricted to a specific type of interaction. For example, some embodiments may count the number of taps or clicks that a user performs on a specified subset of user interface elements, a number of times that a “submit” button is pressed, etc. The application manager 720 may then compare this count value with a threshold and send the count value to the computing system 706 if the count value is greater than or equal to the threshold.

In some embodiments, a server system may send a request to a client device to provide feature values. For example, the computing system 706 may send a prompting message to the user device 702 that causes the user device 702 send one or more feature values back to the computing system 706. In some embodiments, this prompting message may include a definition or set of instructions that characterizes a latent feature value. For example, the computing system 706 or another server system may send an initial message to the user device 702. In response to receiving the initial message, the user device 702 may send one or more feature values to the computing system 706 or another server system, where the one or more feature values may include one or more latent feature values. In some embodiments, the computing system 706 may send definitions, algorithms, program instructions, parameters, or other data to the one or more devices of the user devices 702-705, where the computing system 706 may send such data may be used to determine a latent feature.

In some embodiments, the computing system 706 may send program instructions that create a latent feature definition, which causes the user device 702 to determine latent feature values in accordance with that definition. A latent feature definition may indicate a set of initial feature types that are used to determine a latent feature type. For example, computing system 706 may send program instructions that cause the user device 702 to compute the sum of a first value and a second value of a first set of feature values collected by the user device 702 to use as a first latent feature value. The user device 702 may then send this first latent feature value to the computing system 706, where the computing system 706 may then refine or generate a machine learning model. Alternatively, the computing system 706 may send parameters to a client device that would cause the client device to generate different types of latent features without explicitly defining those latent features. For example, the computing system 706 may send categories of actions and a duration to the user device 702 to limit but not define the types of latent features that may be generated from those actions within that duration. For example, the computing system 706 may send a list of identifiers of a set of 20 different types of actions or other initial features collected by the user device 702. The user device 702 may then randomly select two or more initial feature values to generate latent features by performing a mathematical operation involving the two or more selected features.

In some embodiments, a client device (e.g., a user device of the user devices 702-705) or a server system (e.g., the computing system 706) may determine one latent feature from one or more other latent features. For example, the computing system 706 may receive a first latent feature value for a first set of latent feature types from the user device 702 and a second latent feature value for a second set of latent feature types from the user device 704. The computing system 706 may then generate a third latent feature value using the first and second latent feature values. For example, the first latent feature value is “Yes” and corresponds with a latent feature type indicating whether a user is classified as at risk of fraud, and the second latent feature value is “crypto user”, indicating whether the user has transferred crypto currency using the application 718. After receiving these first and second latent feature values, the computing system 706 may determine, as a feature value for a third latent feature type, a selected category for the user based on a determination that both the first and second in feature values satisfy a respective set of criteria. For example, the computing system 706 may generate, as a feature value for the third latent feature type, the category “high risk” to the user based on a determination that the first latent feature value matches the criteria value “Yes” and the second latent feature value matches the criteria value “crypto user.” The computing system 706 may then use this third latent feature value and other latent feature values for this third latent feature type as training data for a machine learning model to generate an additional trained machine learning model. In some embodiments, the computing system 706 may then use the output of this additional trained machine learning model to perform one or more downstream actions (e.g., lock a user account).

In some embodiments, a client device (e.g., a user device of the user devices 702-705) or a server system (e.g., the computing system 706) may determine a latent feature using both other latent features and initial features. For example, the computing system 706 may receive, from the user device 702, a first feature value for a first type of latent feature and a second feature value for an initial feature that is collected without further computation by the application 718. For example, the computing system 706 may receive, as an initial feature value collected by the user device 702, a transaction count indicating a number of times that a set of database transactions are effectuated by the user device 702. The computing system 706 may also receive, as a latent feature value, an intent vector representing a user's intent calculated by the user device 702 based on text entered into a text entry field. The computing system 706 may then refine or otherwise update a machine learning model using both the transaction count and the intent vector. For example, the computing system 706 may refine the machine learning model 762 into a refined machine learning by updating the machine learning model 762 to include an additional layer (e.g., an additional layer of neural units for a neural network) that accepts, as an input, the intent vector and the transaction count, where an objective for the training may be based on a known classification or category associated with the user.

In some embodiments, a client device (e.g., the user device 702) may determine a latent feature based on whether a set of thresholds are satisfied by initial feature values. For example, the application 718 may assign either a “high spender” or “low spender” category to a user based on whether (1) an amount transferred by a user is greater than a first threshold and (2) whether a remaining account value of the user stays above a second threshold. In the case that the amount transferred is greater than the first threshold and that the remaining account value stays above the second threshold, the application 718 may assign a category “high spender” to the user and send this category value to the computing system 706 for use as a latent feature. Alternatively, or additionally, the computing system 706 may perform a similar set of operations to determine a latent feature value.

In some embodiments, a server system may send, to client devices, parameters for one or more autoencoders or other parameters used to determine latent feature values. For example, the computing system 706 may send a set of autoencoder parameters to the user devices 702-705, where the set of autoencoder parameters may characterize an autoencoder adapted to dimensionally reduce user action data, representing a count of different types of actions over time. After receiving the set of auto encoder parameters, one or more devices of the user devices 702-705 may generate a set of embedding vectors from their respective user's actions and send these embedding vectors back to the computing system 706 as latent feature values. The computing system 706 may then use these latent feature values to refine or generate machine learning models that ingest these embedding vectors as inputs.

In some embodiments, the computing system 706 or one or more devices of the user devices 702-705 may use one or more random processes to determine one or more latent features. For example, the application 718 may randomly select a first subset of values from the set of initial feature values and determine a first result based on the first subset of values. Alternatively, or additionally, the user device 703 may select a second subset of values from a second set of initial feature values and determine a second result based on the second subset of values. Determining a result based on feature values includes using one or more mathematical operators, such as addition, multiplication, exponentiation, logarithmic operations, etc. Determining a result based on feature values may include setting a result to be equal to a nonzero value or “TRUE” if all of the selected feature values are also nonzero or “TRUE” and sending the result to be equal to zero or “FALSE” if one or more of the selected feature values are equal to zero or “FALSE.”

In some embodiments, a server system may select different groups of different devices based on the users associated with those devices for the purpose of collecting different latent features from those groups. For example, the computing system 706 may select a first set of client devices that includes the user device 702 and the user device 703 based on a determination that users of this first set of client devices have been categorized with a first user category (e.g., “general user”). The computing system 706 may then select a second set of client devices that includes the user device 704 and the user device 705 based on the determination that the second set of client devices are used by users categorized with a second user category (e.g., “Mortgage user”). The computing system 706 may then send a first latent feature detection parameter to the first set of client devices and a second latent feature detection parameter to the second set of client devices, where these latent feature detection parameters are different from each other and cause the different sets of devices to provide different types of latent features. For example, the computing system 706 may send, as a first latent feature detection parameter, a first category value to the first set of client devices, where the first latent feature detection parameter indicates a first type of initial feature types. For example, this first type of initial feature types may indicate mortgage activity (e.g., actions related to moving a mortgage prediction slider, entering loan amount for a mortgage into a data entry field, etc.). The computing system 706 may then send, as a second latent feature detection parameter, a second category value indicating a second type of initial feature types to the second set of client devices. For example, this second type of initial feature types may indicate student loan activity (e.g., clicking or tapping on a user interface element relating to a student loan screen, submitting a transaction to pay a monthly payment for a student loan, etc.). In response to receiving the first category value, the first set of client devices may generate latent feature values from initial features of the first type. In response to receiving the second category value, the second set of client devices may generate latent feature values from initial features of the second type.

In some embodiments, one or more devices of the user devices 702-705 may perform obfuscation operations that decrease privacy risks to a user. For example, the communicator 716 may apply a set of noise filters to an outgoing set of latent feature values or other feature values before sending the noise-applied values to the computing system 706. In some embodiments, the set of noise filters may uniformly apply a set of randomly generated values to feature values. Alternatively, or additionally, one or more devices may apply different noise filters to different feature values. For example, the communicator 716 may apply a first randomly generated value to a first feature value and apply a second randomly generated value to a second feature value. In some embodiments, applying a randomly generated value to a feature value may include adding the randomly generated value to the feature value, multiplying the feature value by the randomly generated value, or otherwise modifying the feature value based on the randomly generated value.

Some embodiments may perform bandwidth-saving operations that reduce the total amount of data sent to the computing system 706 from one or more devices of the user devices 702-705. To reduce the total amount of network resources being consumed by one or more operations described in this disclosure, an application executing on a user device may determine that a latent feature is equally or more effective at making predictions than one or more initial features. For example, in some embodiments, the application 718 may use feature values of a subset of initial feature types to generate a latent feature value for a latent feature type and store the latent feature value in the latent features database 728. In some embodiments, a first machine learning model 722a may ingest feature values of the subset of initial feature types to predict whether a user is committing activities indicative of fraud. The user device 702 may further store a second machine learning model that also predicts whether the user is committing activities indicative of fraud, where the second machine learning model may accept the latent feature value for the latent feature type as an input. The application 718 may then compare the performance of the two machine learning models based on data collected by the application 718 and determine that the second machine learning model is as accurate or more accurate than the first machine learning model. In some embodiments, the application 718 may then, after generating latent feature values, prevent feature value data for the subset of initial feature types from being sent to the computing system 706. Instead, the application 718 may send the generated latent feature values to the computing system 706 without sending the feature value data for the subset of initial feature types.

In some embodiments, a server system may send one or more update messages to user devices that cause the devices to send additional feature values of additional feature types indicated by the one or more update messages. For example, the computing system 706 may send an update message to the application 718, where the update message may indicate an additional set of feature types. The additional set of feature types may include various types of features, such as features indicating one or more user actions. After receiving this update message, the application 718 may begin to collect feature values for this additional set of feature types. For example, after receiving an update message indicating metrics related to the acceleration in transaction frequency, the application 718 may collect these metrics for use as feature values.

In some embodiments, the computing system 706 may perform downstream operations based on a prediction or category outputted by a machine learning model described in this disclosure, such as a refined machine learning model. For example, some embodiments may increase one or more values stored in an account record based on a determination that the output of a refined machine learning model indicates that the user identified by that account record qualifies for the value increase. In some embodiments, such a value increase may indicate an increase in credit allocated to the user, an increase in resources available to the user, etc.

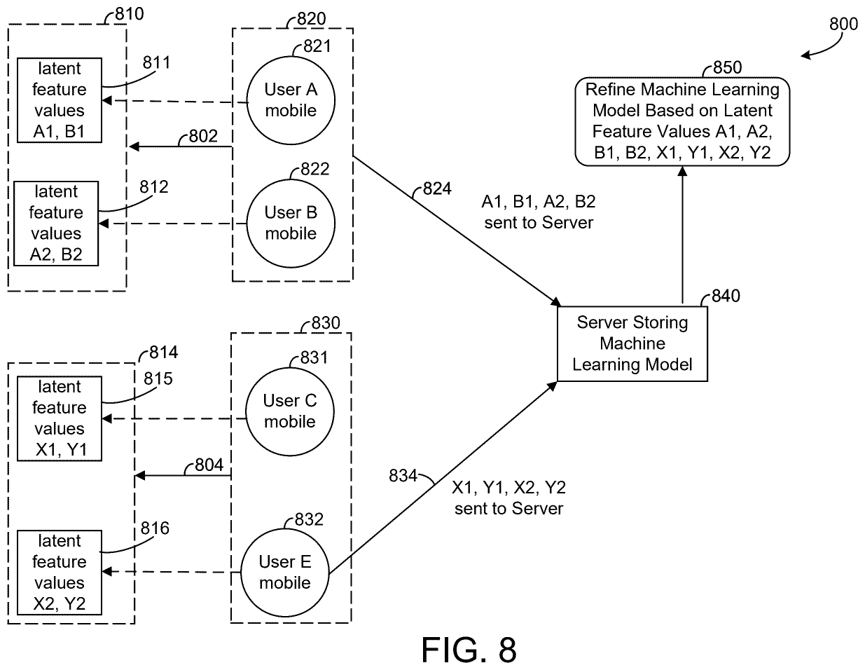

FIG. 8 illustrates an example sequence for refining a machine learning model with different sets of latent features, in accordance with an implementation. A sequence 800 may be performed by components of the system 700, shown and described with reference to FIG. 7. For example, individual operations of the sequence 800 can be performed by at least one of the devices of the user devices 702-705 and the computing system 706. The sequence 800 may include more or fewer operations, and the operations may be performed in any order.

In the sequence 800, at an operation 802, the first set of computing devices 820 may determine a first set of latent feature values 810, where each respective device of the first set of computing devices 820 may generate a respective set of latent feature values. For example, the user device 821 may generate the first subset of latent feature values 811, and the user device 822 may generate the second subset of latent feature values 812. The first set of latent feature values 810 may correspond with a first set of latent feature types “A” and “B.”

Similarly, at an operation 804, the second set of computing devices 830 may determine a second set of latent feature values 814, where each respective device of the second set of computing devices 830 may generate a respective set of latent feature values. For example, the user device 831 may generate the third subset of feature values 815, and the second user device 832 may generate a fourth subset of feature values 816. The second set of latent feature values 814 may correspond with a second set of latent feature types “X” and “Y.” In some embodiments, the second set of latent feature types may be mutually exclusive with respect to the first set of latent feature types. Alternatively, in some embodiments, the second set of latent feature types may share one or more feature types with the first set of latent feature types. For example, both the first and second set of latent feature types may include a ratio of an average transaction amount to an average transaction frequency over the course of one week.

At an operation 824, the first set of computing devices 820 may send the first set of latent feature values 810. In some embodiments, each device of the first set of computing devices 820 may send feature values to the server system 840 concurrently. For example, the user device 821 and the user device 822 may concurrently send the first set of latent feature values 810 (e.g., the values A1, B1, A2, and B2) to the server system 840. Alternatively, or additionally, devices of the first set of computing devices 820 may independently send feature value data to the server system 840. For example, the user device 821 may first send the first subset of latent feature values 811 to the server system 840 for the first time. Then, at a second time, the user device 822 may send the second subset of latent feature values 812 to the server system 840.

At an operation 834, the second set of computing devices 830 may send the second set of latent feature values 814 to the server system 840. In some embodiments, each device of the second set of computing devices 830 may send feature values to the server system 840 concurrently. For example, the user device 831 and the second user device 832 may concurrently send the second set of latent feature values 814 (e.g., values X1, Y1, X2, and Y2) to the server system 840. Alternatively, or additionally, devices of the second set of computing devices 830 may independently send feature value data to the server system 840. For example, the user device 831 may first send the third subset of feature values 815 to the server system 840 for the first time. Then, at a second time, the second user device 832 may send the fourth subset of feature values 816 to the server system 840.

At an operation 850, the server system 840 may refine one or more machine learning models based on the latent feature values collected from the first set of computing devices 820 and the second set of computing devices 830. As described elsewhere in this disclosure, a server system 840 may store a set of machine learning models and distribute this set of machine learning models to the first set of computing devices 820 and the second set of computing devices 830. After receiving the first set of latent feature values 810 and the second set of latent feature values 814, the server system 840 may generate refined versions of the set of machine learning models by either directly retraining the machine learning models or by augmenting one or more machine learning models to handle the latent features as additional inputs. For example, some embodiments may update a machine learning model to include an additional layer that may ingest, as a set of inputs, latent feature values for the latent features A, B, X, and Y. In some embodiments, the server system 840 may add an additional layer that includes additional sub-components of a learning model, such as by incorporating an original machine learning model into an ensemble model that also takes, as inputs, latent features such as the first set of latent feature values 810 and the second set of latent feature values 814.

In some embodiments, outcomes assigned to a user may be used as a training target when generating a refined model. For example, if users of the first set of computing devices 820 are assigned to the category “bluered” and the users of the second set of computing devices 830 are also assigned to the category “bluered,” a computer system may train the machine learning model based on records associating the latent feature values A1, B1, A2, B2, X1, Y1, X2, and Y2 with the category “bluered” to generate a refined machine learning model. In some embodiments, after training, a computer system may use the refined machine learning model to predict this category based on these latent feature values, even if the initial feature values used produce these latent values are not provided to the refined machine learning model.

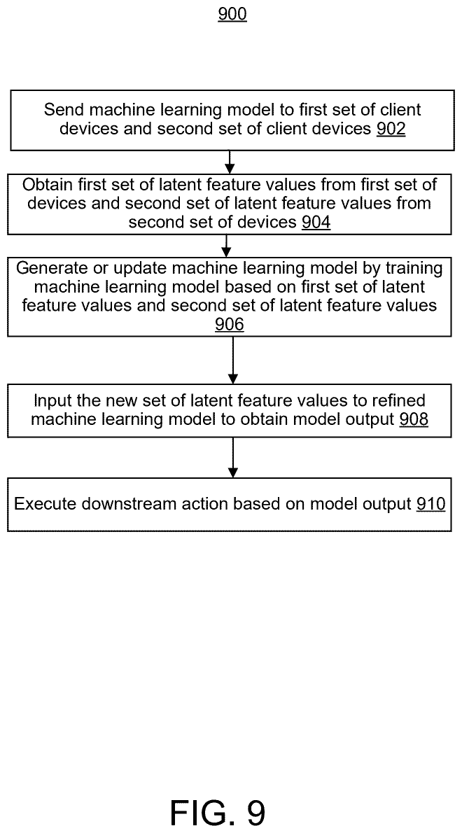

FIG. 9 illustrates an example method 900 for using latent features to perform collaborative machine learning model generation, in accordance with an implementation. The one or more operations described for the method 900 can be performed by a data processing system (e.g., the user device 702, the computing system 706, etc.). The method 900 may include more or fewer operations, and the operations may be performed in any order. Performance of the method 900 may enable the data processing system to collaboratively generate, train, and fine tune machine learning models using latent features determined from other operations.

In the method 900, at an operation 902, the data processing system sends a machine learning model to a first and second set of client devices. The machine learning model may include one of various types of machine learning models, such as neural network learning models, deep belief networks, ensemble machine learning models, Bayesian networks, etc. For example, some embodiments may send parameters characterizing a neural network to multiple client devices. Furthermore, some embodiments may send multiple machine learning models to each of a set of devices.

At an operation 904, the data processing system may obtain a first set of latent feature values from the first set of client devices and obtain a second set of client devices. The data processing system may send an initial message to a client device to cause the client device to send feature data back to the data processing system. For example, a server system may send a client device a prompting message that triggers the client device to send feature data back to the server system. Alternatively, or additionally, a client device may store program instructions that cause the client device to send feature values to the server system without external prompting from the server system or another computing device. For example, an application on a client device may be configured to send feature value data to a server system at regular intervals or when one or more criteria is satisfied.

At an operation 906, the data processing system may generate or update a machine learning model by updating a machine learning model based on the first set of latent feature values and the second set of latent feature values. For example, if a machine learning model being refined is a neural network or includes a neural network model, a server system may freeze the existing layers of the neural network model and add one or more new layers on top of the existing layers that may ingest a latent neural network. Alternatively, or additionally, some embodiments may perform task-specific fine-tuning operations to update a machine learning model. For example, some embodiments may add a task-specific classification head to a neural network model that uses, as inputs, a first set of latent feature values provided by the first set of client devices and a second set of latent feature values provided by the second set of client devices.

While some embodiments may obtain different latent feature values from different groups of client devices, some embodiments may update a machine learning model to ingest latent feature values provided by a shared set of client devices. For example, a server system may obtain values for a first latent feature from multiple client devices, where each respective value of the latent feature values is associated with a corresponding respective classification for a user of a device of the multiple client devices. A server system may then generate or update a machine learning model by adding a layer of neural network units to use the first latent feature as an input by training the machine learning model based on those latent feature values and the user classifications.

At an operation 908, the data processing system may input a new set of latent feature values to the refined machine learning model to obtain a refined model output. A server system may obtain new latent feature values from one or more devices and, in response, provide the newly obtained latent feature values to the refined machine learning model to generate a refined model output. For example, a server system may obtain a first latent feature value and a second latent feature value from a single client device. For example, the first latent feature value may indicate a ratio of a count indicating the number of times that an application's user interface was interacted with relative to a duration for which the application was open, and the second latent feature value may indicate a category assigned to a user of the application. The server system may then provide the first and second latent feature values to the refined model to determine a refined model output, where the refined model output may be a category that indicates whether a user's behavior indicates fraudulent activity.

In some embodiments, a server system may receive heterogeneous latent features from multiple devices. For example, a server system may receive values for first latent feature types from a first client device and values for second latent feature types from a second client device. The first client device may have selected the first latent feature type based on results of a first learning model, and the second client device may have selected the second latent feature type based on results of a second learning model. A server system may determine that users of both the first and second device are classified as a shared user category, where the first learning model may generate a first prediction value for the first user, and where the first prediction value indicates that the user of the first client device is “type 1, where this first prediction value is of a first prediction type, and where the second learning model may indicate that the user of the second client device is “type Alpha,” where this second prediction value is of a second prediction type.

In some embodiments, a server system may then use the first prediction value, the second prediction value, the first latent feature value, and the second latent feature value to generate a refined machine learning model. For example, the server system may have initially stored a neural network to generate a prediction for a user categorized in the shared user category. The server system may then update the neural network by adding a first set of additional layers of neural units that can receive values of the first latent feature type or a second set of additional layers of neural units that can receive values of the second latent feature type. By training a machine learning model using latent feature values of different users of a shared user category, some embodiments may determine more accurate predictions for users of that shared user category.

Some embodiments replace a machine learning model with a refined version of the machine learning model, thereby using the same resources used to execute an original machine learning model. Alternatively, some embodiments may provision computing resources to train and store a new machine learning model for use as the refined model. For example, some embodiments may provision computing resources from a cloud computing system, copy an initial machine learning model, and refine the initial machine learning model with latent feature values and their associated outcomes to generate a refined machine learning model.

In some embodiments, the data processing system may use the refined model to process newly received latent feature data to generate new predictions or classifications. For example, a server system may receive a set of latent feature values and, in response, use a refined model to predict that a user is a “type II” user. Such a prediction may be possible even if an original model used to predict that a user is a “type II” user would require additional user data because a refined model that uses a latent feature may be determined from fewer values than those needed by an original model.

At an operation 910, the data processing system may execute a downstream action based on the model output. In some embodiments, a server system may directly use the refined model to generate a prediction. For example, some embodiments may use a refined machine learning model to detect that a user or user class is behaving in a way indicative of fraud and, in response, lock the records associated with that user or user class to prevent further changes. Alternatively, or additionally, some embodiments may use a refined machine learning model to predict that a user or user category may be classified as being responsive to a message and, in response, send messages to addresses associated with the user or user category. For example, some embodiments may determine that a user or user category is likely to be responsive to a message indicating a future product feature and, in response, send the user or user category the message indicating the future product feature.

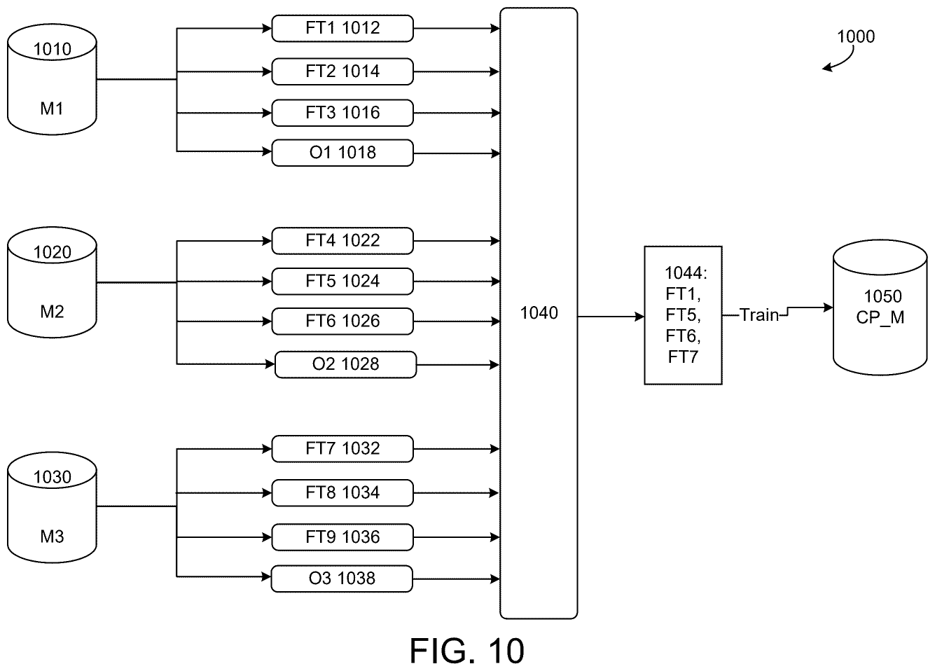

FIG. 10 illustrates a first example system that provides initial feature values usable for training cross-pollinated machine learning models. An example system 1000 includes a first model 1010, a second model 1020, and a third model 1030. The inputs and outputs for each of these models may be different. The system 1000 includes a first model 1010 that uses, as inputs, a first set of initial feature values for a first set of initial feature types that includes a first feature type 1012, a second feature type 1014, and a third feature type 1016. The first model 1010 uses feature values for the first feature type 1012, the second feature type 1014, and the third feature type 1016 to predict an output for a first output type 1018. For example, the first feature type 1012 may relate to stocks (e.g., a total number of stocks traded, a total value of stocks held, etc.), the second feature type 1014 may relate to bonds (e.g., a total number of bonds traded, a total value of bonds held, etc.), and the third feature type 1016 may relate to Electronically Traded Funds (ETFs) (e.g., a total number of ETFs traded, a total value of ETFs held, etc.), and the output of the first model 1010 may indicate whether a user is categorized as “active trader” or “inactive trader” as a feature value for the first output type 1018.

The system 1000 includes a second model 1020 that uses, as inputs, a second set of initial feature values for a second set of initial feature types that includes the fourth feature type 1022, a fifth feature type 1024, and a sixth feature type 1026. The second model 1020 uses feature values for the fourth feature type 1022, the fifth feature type 1024, and the sixth feature type 1026 to predict an output for a second output type 1028. For example, the fourth feature type 1022 may relate to capacity (e.g., a total mortgage capacity, a change in capacity, etc.), the fifth feature type 1024 may relate to credit (e.g., a credit score, a total available credit, etc.), and the sixth feature type 1026 may relate to assets (e.g., a total value of assets, an asset category, etc.), and the output of the second model 1020 may indicate whether a user is categorized as “potential borrower” or “non-potential borrower” as a feature value for the second output type 1028.

The system 1000 includes a third model 1030 that uses a third set of initial feature values for a third set of initial feature types that includes a seventh feature type 1032, an eighth feature type 1034, and a ninth feature type 1036. The second model 1020 uses feature values for the seventh feature type 1032, the eighth feature type 1034, and the ninth feature type 1036 to predict that a user should be assigned a category “Type I” selected from the set [“Type I,” “Type II”]. For example, the seventh feature type 1032 may relate to a checking balance (e.g., a total amount in the balance, a change in the balance, etc.), the eighth feature type 1034 may relate to a certified deposit (e.g., a total amount in the deposit, a change in the certified deposit, etc.), and the ninth feature type 1036 may relate to credit card payments (e.g., a total value of credit card payments, an payment category, etc.), and the output of the third model 1030 may indicate whether a user is categorized as “potential borrower” or “non-potential borrower” as a feature value for the third output type 1038.

In some embodiments, the initial feature values are received by a model wrapper 1040 that may preprocess a set of incoming features for training operations. For example, the model wrapper 1040 may select feature values for collection into a feature value collection 1044, where the collected feature values may include values of the first feature type 1012, fifth feature type 1024, sixth feature type 1026, and seventh feature type 1032. The system 1000 may then use the selected feature values and the corresponding output states predicted by the first model 1010, second model 1020, and third model 1030 for performing a set of training operations to update a set of machine learning. In some embodiments, the system 1000 may store the inputs and outputs of the training operations, which may be stored into a cross-pollinated model database 1050. For example, the system 1000 may store model training data from the feature value collection 1044, first output type 1018, second output type 1028, and third output type 1038. A computer system may use this data to predict output values for the first output type 1018, second output type 1028, and third output type 1038 after being provided with feature values for the first feature type 1012, fifth feature type 1024, sixth feature type 1026, and seventh feature type 1032.

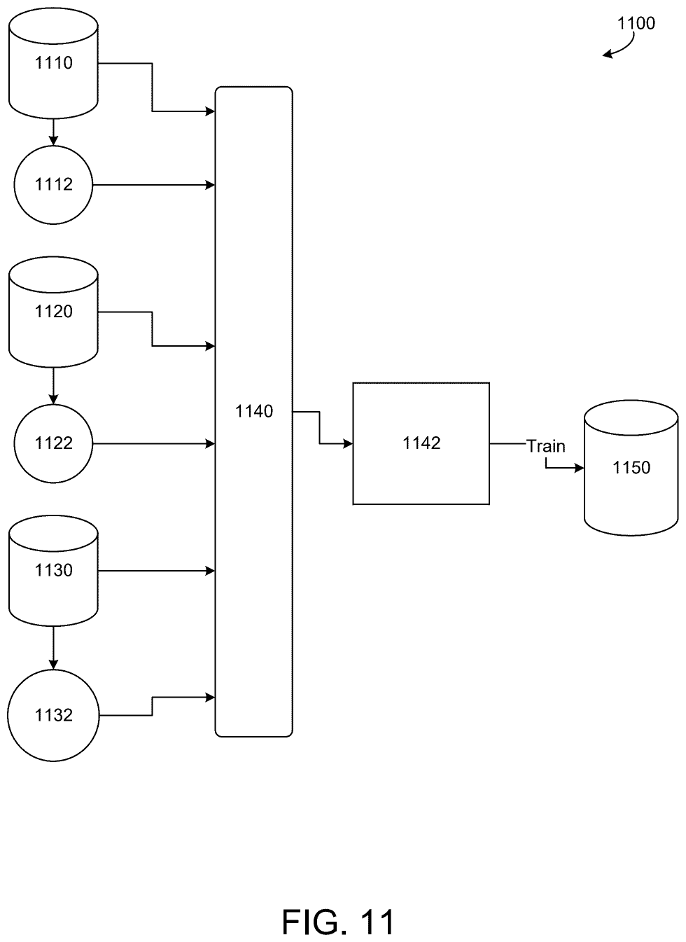

FIG. 11 illustrates a second example system that provides latent feature values usable for training cross-pollinated machine learning models. An example system 1100 includes a first model 1110, a second model 1120, and a third model 1130. The first model 1110 may output a value for a first model output type 1112, the second model 1120 may output a value for a second model output type 1122, and the third model 1130 may output a value for a third model output type 1132. In some embodiments, the model output for the first model output type 1112, the second model output type 1122, and the third model output type 1132 may be sent to a model wrapper 1140, which may then be sent to a feature collection 1142. The feature collection 1142 may include inputs and outputs to one or more models of the first model 1110, the second model 1120, and the third model 1130 for use as training data inputs. For example, such inputs may include values for the second model output type 1122 and the third model output type 1132.

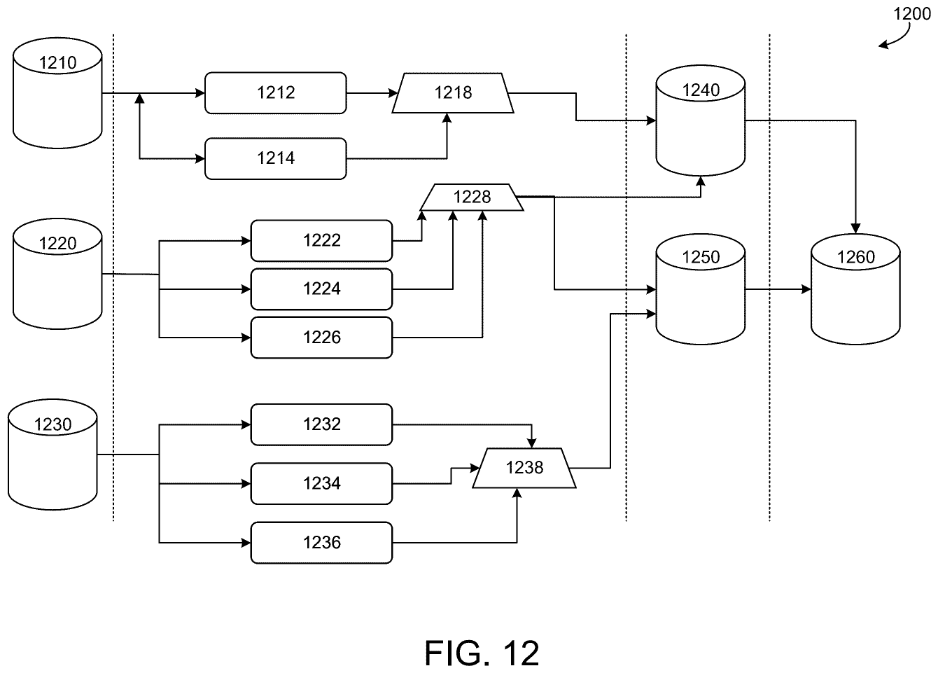

FIG. 12 illustrates a first example system that uses latent feature values to train machine learning models. The system 1200 includes a first model 1210 that uses feature values for a first initial feature type 1212 and a second initial feature type 1214. The first model 1210 may also use the feature values for the first initial feature type 1212 and the second initial feature type 1214 to produce a first latent feature value for a first latent feature type 1218. For example, the first latent feature type 1218 may be the output of a service that generates a machine learning output indicating whether the image-criteria related to color, resolution, or object detection are satisfied by the first initial feature type 1312, the 1314//, and the 1316//.

The system 1200 includes a second model 1220 that may use, as inputs, feature values for a third initial feature type 1222, a fourth initial feature type 1224, and a fifth initial feature type 1226. The second model 1220 may also use, as an input, a latent feature value for a second latent feature type 1228, where the value for the second latent feature type 1228 may be determined from values for the third initial feature type 1222, fourth initial feature type 1224, and fifth initial feature type 1226. For example, the second latent feature type 1228 may be the output of a function that multiples the values for the third initial feature type 1222, the fourth initial feature type 1224, and the fifth initial feature type 1226.

The system 1200 includes a third model 1230 that includes a sixth initial feature type 1232, a seventh initial feature type 1234, and an eighth initial feature type 1236. In some embodiments, a function or rule system may use feature values for the sixth initial feature type 1232, the seventh initial feature type 1234, and the eighth initial feature type 1236 to produce a third latent feature type 1238. For example, the third latent feature type 1238 may be the output of a rule-based engine that outputs a category based on whether the values for the sixth initial feature type 1232, seventh initial feature type 1234, and the 1236 satisfy a set of minimum or maximum thresholds.

In some embodiments, a computer system may send values for the first latent feature type 1218 and the second latent feature type 1228 to a first downstream model 1240 to train the first downstream model 1240. For example, the first downstream model 1240 may be trained to detect and categorize risk behaviors, such as “impermissibly risky” and “acceptable risk range.” Furthermore, the computer system may send feature values for the second latent feature type 1228 and the third latent feature type 1238 to a second downstream model 1250. The second downstream model 1250 may then produce an output based on these latent feature values. For example, the second downstream model 1250 may output a category value indicating whether a user is a “high” or “low” user. In some embodiments, outputs of a downstream model may then themselves be used as inputs for a further downstream model. For example, outputs of the first downstream model 1240 and of the second downstream model 1250 may be used as inputs for a third downstream model 1260. The third downstream model 1260 may then output a category indicating whether to send the user a response message, to lock the account record for the user, or perform some other downstream action. For example, a computer system may use the third downstream model 1260 to produce an output “send message” based on the outputs of the first downstream model 1240 and the second downstream model 1250 for a user. In response, the computer system may send a message indicating a preferred reward option to the user.

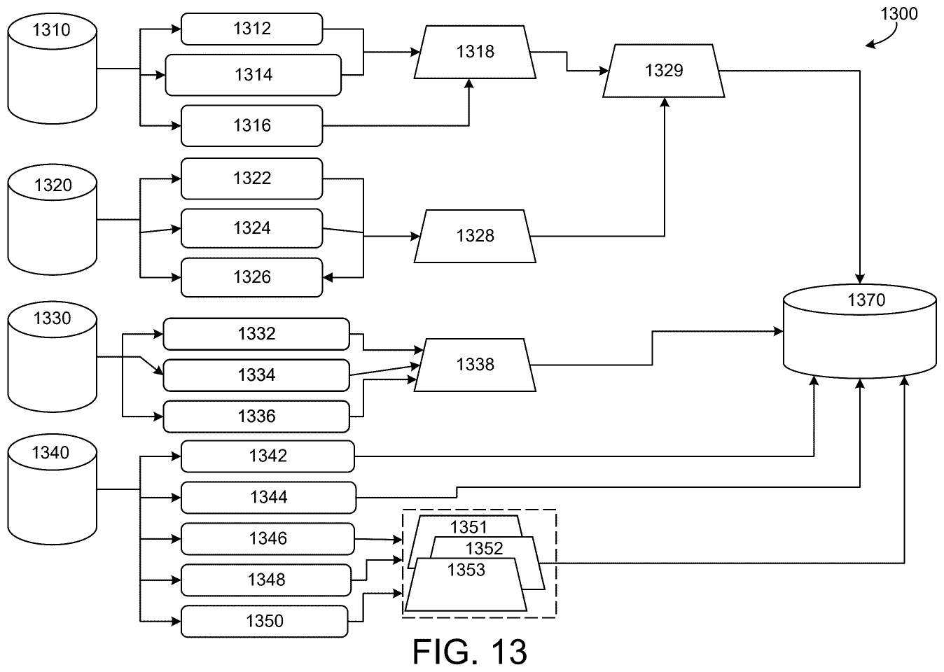

FIG. 13 illustrates a second example system that uses latent feature values to train machine learning models. In some embodiments, a system 1300 may incorporate data related to frequency of use of an application feature, session-related information, or impressions indicating user sentiment. In some embodiments, such data or data derived from such data may be used to refine a downstream model, such a model, to determine the priority of a product for a user.

The system 1300 includes a first machine learning model 1310 that uses, as inputs, a set of feature values for a first initial feature type 1312, a second initial feature type 1314, and a third initial feature type 1316. Some embodiments may further determine a latent feature value for latent feature type 1318 by providing the feature values for the first initial feature type 1312 and the third initial feature type 1316 to the function. For example, a computer system may use the first initial feature type 1312 to represent certified deposits, the second initial feature type 1314 to represent an account balance, and the third initial feature type 1316 to represent transactional activity. The computer system may then provide, as inputs, values of the first initial feature type 1312, the second initial feature type 1314, and the third initial feature type 1316 to a rules-based subsystem to determine a value for the latent feature type 1318, representing an indicator of overall performance.

The system 1300 also includes a second machine learning model 1320, where inputs to the second machine learning model 1320 may include values for a fourth feature type 1322, a fifth feature type 1324, and a sixth feature type 1326. In some embodiments, a computer system may determine a value for a second latent feature type 1328. Furthermore, in some embodiments, the second machine learning model 1320 may include a model to process audio information, such as speech or sounds. Some embodiments may perform operations to convert audio information into text data using the second machine learning model 1320 and then determine fees or sentiments for use as inputs to a machine learning model or to determine a latent feature value. For example, the fourth feature type 1322 may indicate whether a maintenance fee was increased, the fifth feature type 1324 may indicate an overdraft fee, and a sixth feature type 1326 may represent the sentiment of a user providing speech data or other audio data. The second latent feature type 1328 may then be used as inputs for a function to indicate a latent feature value for the second latent feature type 1328, where the second latent feature type 1328 may represent a value indicating user loyalty. Furthermore, a client system may use the latent feature values for the latent feature type 1318 and the second latent feature type 1328 to generate a feature value for a downstream latent feature type 1329 (e.g., by using these latent feature values as inputs for a function).

The system 1300 also includes a third machine learning model 1330, where inputs to the third machine learning model 1330 may include values for feature types 1332, 1334, and 1336. Some embodiments may use values for the feature types 1332, 1334, and 1336 to determine values for a third latent feature value 1338. In some embodiments, the third machine learning model 1330 may be or may include a machine learning model that converts images into text and then analyzes the text to determine future values corresponding with the feature types 1332, 1332, or 1336. By incorporating data from different models and different input types, some embodiments may produce these multimodal outputs.

The system 1300 also includes a fourth machine learning model 1340, where inputs to the fourth machine learning model 1340 may include values for the feature types 1342, 1344, 1346, 1348, and 1350. In some embodiments, the fourth machine learning model 1340 may include a model to convert video into text data. In some embodiments, a client system may generate multiple latent feature values for multiple latent feature types 1351-1353 from the values for the feature types 1342, 1344, 1346, 1348, and 1350. The client system may evaluate the latent feature types to determine their effectiveness for predicting outputs of the fourth machine learning model 1340, where the client system may select values of the latent feature type 1352 to send to a server system.

In some embodiment, a client device may send each of the downstream latent feature type 1329, the third latent feature value 1338, the feature types 1342, the feature types 1344, and the latent feature type 1352 to a server system, where the server system may then perform training operations to refine a machine learning model to form a refined model 1370.

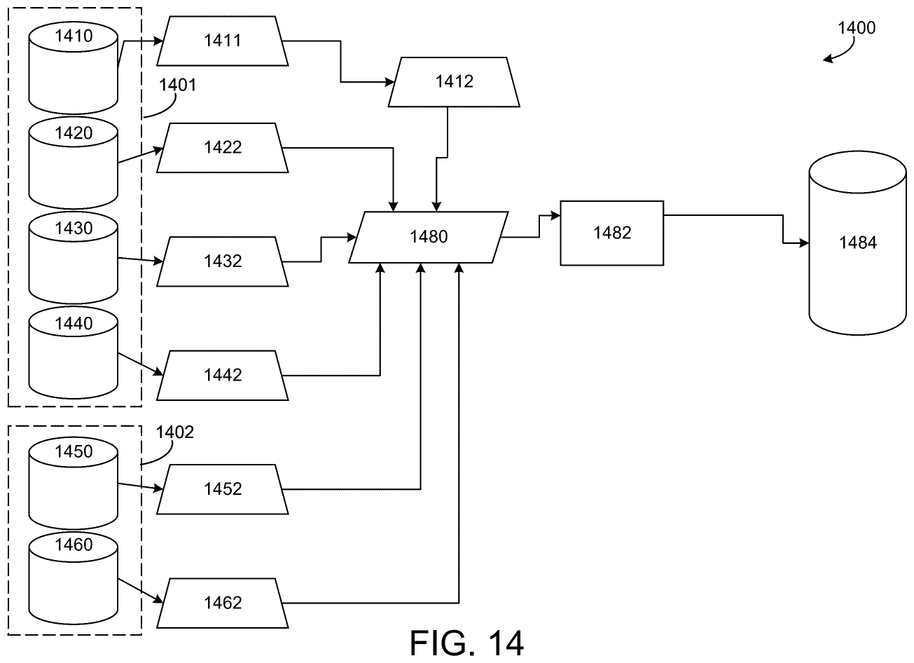

FIG. 14 illustrates a third example system that uses latent feature values to train machine learning models. The system 1400 includes a first model 1410, a second model 1420, a third model 1430, a fourth model 1440, a fifth model 1450, and a sixth model 1460. In some embodiments, one or more of the models may include data provided in different formats. For example, the fifth model 1450 may include a speech processing module to predict a set of outputs and consume one or more latent features as inputs. As another example, the sixth model 1460 may include an image-to-text model that may form a prediction or category based on data derived from images. In some embodiments, a client system may use the first model 1410 to determine or select a first latent type 1411. Similarly, the client may use values of the first latent variable 1411 to determine values for a downstream latent type 1412.

In some embodiments, one or more client systems may use different models to determine or select latent feature types to send to the server system for training a downstream model. A first client device 1401 may use the second model 1420 to determine or select a second latent type 1422, use the third model 1430 to determine or select a third latent type 1432, and use the fourth model 1440 to determine or select a fourth latent type 1442. A second client device 1402 may then use the fifth model 1450 to determine or select a fifth latent type 1452 and use the sixth model 1460 to determine or select a sixth latent type 1462. In some embodiments, the first client device 1401 and the second client device 1402 may send values for the fifth model 1450, the second latent type 1422, the third latent type 1432, the fourth latent type 1442, the fifth latent type 1452, and the sixth latent type 1462 to a wrapper 1480 that may then process these latent feature values to prioritize which are most likely to be useful for training operations. In some embodiments, the wrapper 1480 may produce a latent feature type collection 1482 by determining which of the latent features are most correlated with predicted outputs of their respective model. For example, the wrapper 1480 may select the third latent type 1432, the fourth latent type 1442, and the fifth latent type 1452 for downstream training operations based on a determination that these values are most correlated with a set of predictions made by the third model 1430, the fourth model 1440, and the fifth model 1450.

In some embodiments, users of both the first client device 1401 and the second client device 1402 are indicated to be in a shared user category, where other users may be assigned to other user categories. In some embodiments, a machine learning model may be initially trained to assign users of this shared user category with a value selected from a set of category values based on initial input data for the first model 1410, second model 1420, third model 1430, fourth model 1440, fifth model 1450, and sixth model 1460. In some embodiments, a server system may use the features of the latent features identified in the latent feature type collection 1482 in combination with outcome predictions of the first client device 1401 and the second client device 1402 to train a cross-pollinated machine learning model 1484.

### Computing Environment

FIG. 15 discloses a computing environment 1500 in which aspects of the present disclosure may be implemented. A computing environment 1500 is a set of one or more virtual or physical computers 1510 that individually or in cooperation achieve tasks, such as implementing one or more aspects described herein. The computers 1510 have components that cooperate to cause output based on input. Example computers 1510 include desktops, servers, mobile devices (e.g., smart phones and laptops), payment terminals, wearables, virtual/augmented/expanded reality devices, spatial computing devices, virtualized devices, other computers, or combinations thereof. In particular example implementations, the computing environment 1500 includes at least one physical computer.

The computing environment 1500 may specifically be used to implement one or more aspects described herein. In some examples, one or more of the computers 1510 may be implemented as a user device, such as a mobile device, and others of the computers 1510 may be used to implement aspects of a machine learning framework usable to train and deploy models exposed to the mobile device or provide other functionality, such as through exposed application programming interfaces.

The computing environment 1500 can be arranged in any of a variety of ways. The computers 1510 can be local to or remote from other computers 1510 of the computing environment 1500. The computing environment 1500 can include computers 1510 arranged according to client-server models, peer-to-peer models, edge computing models, other models, or combinations thereof.

In many examples, the computers 1510 are communicatively coupled with devices internal or external to the computing environment 1500 via a network 1590. The network 1590 is a set of devices that facilitate communication from a sender to a destination, such as by implementing communication protocols. Example network 1590 include local area networks, wide area networks, intranets, or the Internet.

In some implementations, computers 1510 can be general-purpose computing devices (e.g., consumer computing devices). In some instances, via hardware or software configuration, computers 1510 can be special purpose computing devices, such as servers able to practically handle large amounts of client traffic, machine learning devices able to practically train machine learning models, data stores able to practically store and respond to requests for large amounts of data, other special purpose computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 1510 include one or more processors 1512, memory 1514, and one or more interfaces 1518. Such components can be virtual, physical, or combinations thereof.

The one or more processors 1512 are components that execute instructions, such as instructions that obtain data, process the data, and provide output based on the processing. The one or more processors 1512 often obtain instructions and data stored in the memory 1514. The one or more processors 1512 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 1512 include at least one physical processor implemented as an electrical circuit. Examples of one or more processors 1512 may include INTEL, AMD, QUALCOMM, TEXAS INSTRUMENTS, and APPLE processors.

The memory 1514 is a collection of components configured to store instructions 1516 and data for later retrieval and use. The instructions 1516 can, when executed by the one or more processors 1512, cause the execution of one or more operations that implement aspects described herein. In many examples, the memory 1514 may be one or more non-transitory, machine-readable media, such as random access memory, read-only memory, cache memory, registers, portable memory (e.g., enclosed drives or optical disks), mass storage devices, hard drives, solid state drives, other kinds of memory, or combinations thereof. In certain circumstances, transitory memory 1514 can store information encoded in transient signals.

The one or more interfaces 1518 are components that facilitate receiving input from and providing output to something external to the computer 1510, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors, such as those using the Global Positioning System), other input components, or combinations thereof (e.g., a touch sensitive display). The one or more interfaces 1518 can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as WI-FI, cellular, BLUETOOTH, ZIGBEE, or other protocols). One or more of the one or more interfaces 1518 can facilitate connection of the computing environment 1500 to a network 1590.

The computer 1510 can include any of a variety of other components to facilitate the performance of operations described herein. Example components include one or more power units (e.g., batteries, capacitors, power harvesters, or power supplies) that provide operational power, one or more buses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries (e.g., libraries that provide functions for obtaining, processing, and presenting data), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions), among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Machine Learning Framework

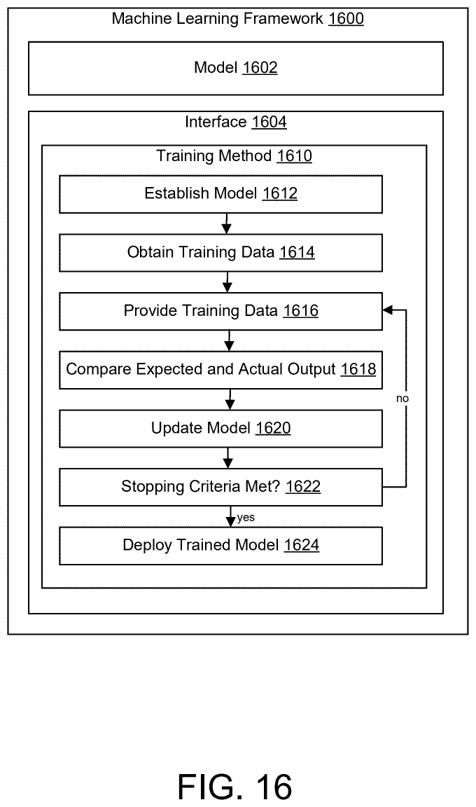

FIG. 16 illustrates an example machine learning framework 1600 that techniques described herein may benefit from. A machine learning framework 1600 is a collection of software and data that implements artificial intelligence trained to provide output, such as predictive data, based on input. Examples of artificial intelligence that can be implemented with machine learning ways include neural networks (including recurrent neural networks), language models (including so-called “large language models”), generative models, natural language processing models, adversarial networks, decision trees, Markov models, support vector machines, genetic algorithms, others, or combinations thereof. A person of skill in the art, having the benefit of this disclosure, will understand that these artificial intelligence implementations need not be equivalent to each other and may instead select from among them based on the context in which they will be used. Machine learning frameworks 1600 or components thereof are often built or refined from existing frameworks, such as TENSORFLOW by GOOGLE, INC. or PYTORCH by the PYTORCH community.

The machine learning framework 1600 can include one or more models 1602 that are the structured representation of learning and an interface 1604 that supports use of the model 1602.

The model 1602 can take any of a variety of forms. In many examples, the model 1602 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 1602 can include a representation of memory (e.g., providing long short-term memory functionality). Where the set includes more than one model 1602, the models 1602 can be linked, cooperate, or compete to provide output.

The interface 1604 can include software procedures (e.g., defined in a library) that facilitate the use of the model 1602, such as by providing a way to establish and interact with the model 1602. For instance, the software procedures can include software for receiving input, preparing input for use (e.g., by performing vector embedding, such as using Word2Vec, BERT, or another technique), processing the input with the model 1602, providing output, training the model 1602, performing inference with the model 1602, fine-tuning the model 1602, other procedures, or combinations thereof.

In an example implementation, interface 1604 can be used to facilitate a training method 1610 that can include operation 1612. Operation 1612 includes establishing a model 1602, such as initializing a model 1602. The establishing can include setting up the model 1602 for further use (e.g., by training or fine tuning). The model 1602 can be initialized with values. In examples, the model 1602 can be pretrained. Operation 1614 can follow operation 1612. Operation 1614 includes obtaining training data. In many examples, the training data includes pairs of input and desired output given the input. In supervised or semi-supervised training, the data can be prelabeled, such as by human or automated labelers. In unsupervised learning, the training data can be unlabeled. The training data can include validation data used to validate the trained model 1602. Operation 1616 can follow operation 1614. Operation 1616 includes providing a portion of the training data to the model 1602. This can include providing the training data in a format usable by the model 1602. The framework 1600 (e.g., via the interface 1604) can cause the model 1602 to produce an output based on the input. Operation 1618 can follow operation 1616. Operation 1618 includes comparing the expected output with the actual output. In an example, this can include applying a loss function to determine the difference between expected and actual. This value can be used to determine how training is progressing. Operation 1620 can follow operation 1618. Operation 1620 includes updating the model 1602 based on the result of the comparison. This can take any of a variety of forms depending on the nature of the model 1602. Where the model 1602 includes weights, the weights can be modified to increase the likelihood that the model 1602 will produce the correct output given an input. Depending on the model 1602, backpropagation or other techniques can be used to update the model 1602. Operation 1622 can follow operation 1620. Operation 1622 includes determining whether a stopping criterion has been reached, such as based on the output of the loss function (e.g., actual value or change in value over time). In addition to, or instead, whether the stopping criterion has been reached can be determined based on a number of training epochs that have occurred or an amount of training data that has been used. In some examples, satisfaction of the stopping criterion can include If the stopping criterion has not been satisfied, the flow of the method can return to operation 1614. If the stopping criterion has been satisfied, the flow can move to operation 1622. Operation 1622 includes deploying the trained model 1602 for use in production, such as providing the trained model 1602 with real-world input data and producing output data used in a real-world process. The model 1602 can be stored in memory 1514 of at least one computer 1510 or distributed across memories of two or more such computers 1510 for production of output data (e.g., predictive data).

### APPLICATION OF TECHNIQUES

Techniques herein may be applicable to improving technological processes of a financial institution, such as technological aspects of actions (e.g., resisting fraud, entering loan agreements, transferring financial instruments, or facilitating payments). Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more. As used in this disclosure, a random process may include a pseudorandom process that involves the use of one or more algorithms to generate pseudorandom values. A random process may also include a physics-based random process that involves the use of a physical measurement to generate a random value.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage the training of a machine learning model with a diverse set of training data. Further, the policy can encourage testing for, and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer system for reducing centralized computing load and bandwidth consumption during federated operations by using latent features from different devices, the system comprising a computer system that comprises one or more processors programmed with computer program instructions that, when executed, cause the computer system to:
send, via a federated network, a model to a first set of client devices of the federated network and a second set of client devices of the federated network for determining different sets of latent features at the first and second sets of client devices, wherein:
the model is trained to ingest an initial set of features indicating user interactions to output one or more learning model outputs;
the first set of client devices generates a first set of latent feature types based on first initial feature values of the first set of client devices, the first initial feature values indicating actions executed at the first set of client devices; and
the second set of client devices generates a second set of latent feature types based on second initial feature values of the second set of client devices, the second initial feature values indicating actions executed at the second set of client devices;
obtain (i) first latent feature values for the first set of latent feature types from the first set of client devices and (ii) second latent feature values for the second set of latent feature types from the second set of client devices, wherein a bandwidth consumption of first latent feature values is less than a bandwidth consumption of the initial set of features; and
refining the model to use, as input, features of the first set of latent feature types and the second set of latent feature types by training the refined model based on the first latent feature values and the second latent feature values, wherein an output of the refined model indicates whether to generate a message indicating additional record values of one or more records associated with the features the first set of latent feature types and the second set of latent feature types.

2. A method for reducing centralized computing load and bandwidth consumption comprising:
sending, from a server system, a model to a first set of client devices and a second set of client devices, wherein:
the model is trained to use, as a set of inputs, an initial set of features;
the first set of client devices generates first latent feature values for a first set of latent feature types based on first initial feature values of the first set of client devices; and
the second set of client devices generates second latent feature values for a second set of latent feature types based on second initial feature values of the second set of client devices;
obtaining, by the server system, the first latent feature values from the first set of client devices and the second latent feature values from the second set of client devices;
training, by the server system, a refined model that uses, as inputs, features of the first set of latent feature types and the second set of latent feature types based on the first latent feature values and the second latent feature values.

3. The method of claim 2, further comprising:
obtaining, by the server system, a new set of latent feature values for the first latent feature type and the second latent feature type from a user account;
inputting, by the server system, the new set of latent feature values to the refined model to obtain a model output; and
sending, from the server system, a candidate message indicating a record value of the user account based on the model output.

4. The method of claim 2, wherein:
the model is a first model;
the initial set of features is a first initial set of features;
the method further comprises sending a second model to the first set of client devices;
the second model uses a second initial set of features as a set of inputs; and
at least one feature value of the first latent feature values is determined from both a value of the first initial set of features and a value of the second initial set of features by comparing whether each of the value of the first initial set of features and the value of the second initial set of features satisfy a set of thresholds.

5. The method of claim 2, wherein:
one or more feature values of the initial set of features indicates user interactions performed in an application, wherein an instance of the application executed by a client device of the first set of client devices causes the client device of the first set of client devices to:
determine a count of times that a first type of user interaction is performed;
determine a result indicating that the count of times satisfies a threshold; and
send a message comprising at least one feature value to the server system based on the result; and
wherein obtaining first latent feature values comprises obtaining, by the server system, a latent feature value of the first latent feature values via the message.

6. The method of claim 2, further comprising sending, by the server system, an initial message to the first set of client devices to send feature values back to the server system, wherein obtaining the first latent feature values comprises obtaining, by the server system, the first latent feature values in response to the initial message.

7. The method of claim 2, further comprising:
determining, by the server system, third feature values for a third latent feature type based on the first set of latent feature types and the second set of latent feature types; and
training, by the server system, a third model based on the third feature values to obtain an additional trained model that ingests values of the third latent feature type.

8. The method of claim 2, wherein training the refined model based on the first latent feature values comprises training, by the server system, the refined model based on both the first latent feature values and feature values of at least one of the initial set of features.

9. The method of claim 2, wherein determining a first latent feature value of the first latent feature values comprises:
determining, by the server system, a first result indicating that a first value of the initial set of features satisfy a first threshold;
determining, by the server system, a second result indicating that a second value of the initial set of features satisfy a second threshold; and
determining, by the server system, the first latent feature value based the first result and the second result.

10. The method of claim 2, further comprising sending, by the server system, a set of autoencoder parameters to the first set of client devices, wherein the first set of client devices determines the first latent feature values based on the set of autoencoder parameters.

11. The method of claim 2, wherein the first set of client devices determines the first latent feature values by:
randomly selecting, by the server system, a first subset of values of the first initial feature values; and
determining, by the server system, a latent feature value based on the first subset of values.

12. One or more non-transitory, machine-readable media storing program instructions that, when executed by one or more processors, causes the one or more processors to:
send, from a server system, a model to a first set of client devices and a second set of client devices, wherein:
the model uses, as a set of inputs, an initial set of features;
the first set of client devices derives a first set of latent feature types based on first initial feature values of the first set of client devices; and
the second set of client devices derives a second set of latent feature types based on second initial feature values of the second set of client devices;
obtain first latent feature values for the first set of latent feature types from the first set of client devices and second latent feature values for the second set of latent feature types from the second set of client devices; and
generate a refined model based on the model, wherein the refined model uses, as inputs, features of the first set of latent feature types and the second set of latent feature types based on the first latent feature values and the second latent feature values.

13. The one or more non-transitory, machine-readable media of claim 12, wherein the one or more processors is further caused to send a latent feature definition indicating a set of initial feature types to the first set of client devices, wherein the first set of client devices determines the first latent feature values based on the latent feature definition.

14. The one or more non-transitory, machine-readable media of claim 12, wherein the one or more processors is further caused:
determine that the first set of client devices is associated with a first user category;
determine that the second set of client devices is associated with a second user category;
send a first latent feature detection parameter to the first set of client devices based on the determination that the first set of client devices is associated with the first user category, wherein the first set of client devices derives the first latent feature values using the first latent feature detection parameter; and
send a second latent feature detection parameter to the first set of client devices based on the determination that the second set of client devices is associated with the second user category, wherein the second set of client devices derives the second latent feature values using the second latent feature detection parameter.

15. The one or more non-transitory, machine-readable media of claim 12, wherein the model comprises a neural network, and wherein the program instructions to generate the refined model comprises program instructions to train a first version of the model that includes at least one additional layer of the neural network, and wherein the refined model comprises the first version.

16. The one or more non-transitory, machine-readable media of claim 15, wherein the model is a first model, and wherein the first set of client devices deletes the first model after receiving the refined model.

17. The one or more non-transitory, machine-readable media of claim 12, wherein the first set of client devices apply a set of noise filters to the first latent feature values before providing the first latent feature values to the server system.

18. The one or more non-transitory, machine-readable media of claim 12, wherein the one or more processors is further caused to:
determine a subset of initial feature types used to determine the first initial feature values and the second initial feature values;
send a message indicating the subset of initial feature types to the first set of client devices, wherein receiving the message prevents the first set of client devices from sending feature value data of the subset of initial feature types to the server system.

19. The one or more non-transitory, machine-readable media of claim 12, wherein the one or more processors is further caused to send an update message to an application executing on at least one device of the first set of client devices, wherein the update message indicates an additional set of feature types, and wherein receiving the update message causes the at least one device to begin collecting feature value data for the additional set of feature types.

20. The one or more non-transitory, machine-readable media of claim 12, wherein the one or more processors is further caused to increase, by the server system, a value stored in an account record based on an output of the refined model.
